(19) United States
(12) Patent Application Publication
(10) Pub. No.: US 2016/0048874 A1
(43) Pub. Date: Feb. 18, 2016

(54) A REAL ESTATE PROPERTY CONTENT SYSTEM, METHOD AND COMPUTER READABLE MEDIUM

(71) Applicant: 4142403 CANADA INC, Toronto (CA)

(72) Inventors: Douglas BRAJER, Toronto (CA); Igor TOKAREV, Woodbridge (CA)

(21) Appl. No.: 14/441,763

(22) PCT Filed: Nov. 8, 2013
(86) PCT No.: PCT/CA2013/000947

§ 371 Date: May 8, 2015

Related U.S. Application Data
(60) Provisional application No. 61/724,277, filed on Nov. 8, 2012.

(51) Int. Cl. G06Q 30/02; G06Q 50/16; G06F 17/30

(52) U.S. Cl. CPC G06Q 30/0256; G06F 17/30525; G06F 17/30241; G06Q 50/16

(57) ABSTRACT

Systems, methods and computer readable media are for use with databases and selected real estate advertisements presented by search engines in response to input from users. They enable receipt of real estate pass-through data, and automatic determination of: predefined information corresponding with the real estate advertisements; and real estate hotlist queries based thereon and on the real estate pass-through data. They enable sending the real estate hotlist queries to the databases and, in response, determination and receipt of real estate property listing data and market information for presentation to the users. The real estate property listing data and market information are automatically processed to determine a real estate hotlist output for presentation to the users. Thus, the real estate advertisements and the input are used to automatically determine the real estate property listing data and market information for presentation to the users.

### FIELD OF THE INVENTION

The present disclosure relates generally to a system, method and computer readable medium for use with real estate data and, in particular, to the selection, arrangement and presentation of real estate property listings and market information.

### BACKGROUND OF THE INVENTION

In the real estate industry, numerous systems and/or methods may have been adapted to select, arrange, and/or present real estate property listings and real estate market information. Some prior art systems and/or methods may have included Internet data exchange (“IDX”) systems or interfaces, which may have been based on a model wherein a large list of real estate properties may have been sourced from property data, and then filtered by user input 20 which specified additional criteria to refine the list. When the list was refined to the user's preferences, the filters or criteria may have been saved so that, in the future, a prior art user could quickly revisit or regenerate similar lists with updated property information.

Previously, to even attempt to implement any of the speed and efficiency benefits detailed in point (1) above, prior art IDX models may have required IDX-providers to anticipate various sets of property criteria that users might be interested in. IDX-providers may then have been required to create groups of “saved search criteria” in their IDX system, and publish links to the property lists generated by those groups. Persons having ordinary skill in the art may appreciate that this process might have been a time-consuming one for IDX-providers.

Previously, to even attempt to allow a user to navigate directly to a list of properties (e.g., condominiums) for sale in a given location or neighborhood, prior art IDX-providers may have been required to create a group of saved search criteria for available properties in every one of these locations or neighborhoods, and then publish links directly to the lists generated by those criteria. Heretofore, it also may have been necessary for such prior art processes to have been repeated for other popular property lists (e.g., single family homes).

In the prior art, one limitation associated with searching for real estate property listings may have been an inability to analyze the details of a specific property (or group of properties) and/or, based on the analysis, intelligently generate a list of similar properties. For example, a search result for a property in a specific neighborhood (e.g., Lincoln Park) generated by prior art systems and/or methods for a user may not have been able to be adapted to include properties in comparable neighborhoods (e.g., North Side).

In addition, for prior art systems and/or methods, statistical reports for real estate market information may not have been adapted to generate a substantially on-demand property list without additional input by the user. Instead, prior art systems and/or methods may have been adapted to calculated reports in advance using a wide selection of data in the aim of increasing the report's usefulness to a larger number of users.

For example, in the prior art, to allow users to navigate directly to lists of given neighborhoods in a city, a provider previously using prior art systems may have been required to create a group of saved search criteria for each and every one of these areas, and then publish links directly to the lists generated by those criteria. In the prior art, this process would have to be repeated for lists based on more specific criteria, e.g., such as condos and/or rental properties.

What may be needed is a system, method, and/or computer readable medium that overcomes, traverses, obviates and/or mitigates one or more of the limitations associated with the prior art and/or helps to do so. It may be advantageous to provide a system, method, and/or computer readable medium for presenting intelligently arranged real estate data to a user without requiring the user to enter additional data to determine the desired real estate properties and determine the desired market information.

It may be advantageous to provide a system, method, and/or computer readable medium adapted to (1) increase speed and/or efficiency in allowing a user to find and/or navigate to additional real estate information; and/or (2) increase search engine optimization, and/or the adaptive header information to contain relevant keywords and/or terms which may be indexed by search engines, preferably allowing the REPCS-provider's website to be more easily located in future searches.

In addition, however, the system, method and computer readable medium according to the present invention may preferably also use knowledge interpretation to perform the refinement process for the user, helping to arrive at a desired list of property information with less direct user input or manipulation.

It may be an object of one aspect of the present invention to provide a real estate property content system, method and computer readable medium.

It may be an object of one aspect of the present invention to provide a system, method, and/or computer readable medium for selecting, manipulating, and displaying real estate property data (e.g., real estate property listings) and/or related information content (e.g., market statistics and/or reports).

It may be an object of one aspect of the present invention to provide a system, method, and/or computer readable medium for selecting, arranging, and presenting real estate property data (e.g., real estate property listings) and/or related information content (e.g., market statistics and/or reports).

It may be an object of one aspect of the present invention to provide a system, method, and/or computer readable medium that is adapted to automatically use knowledge interpretation to, without additional user input, refine lists to arrive at a desired list of property information.

It may be an object of one aspect of the present invention to provide a system, method, and/or computer readable medium that, on receiving a user request, parse the input, consult an internal system of rules and definitions, and determine: the property data to select; any statistical calculations to be performed on that data; and appropriate web page layouts for the final hot list output.

It may be an object of one aspect of the present invention to provide a system, method, and/or computer readable medium adapted to provide final hot list output including: property listing data; an intelligently constructed web page layout with additional content (e.g., market statistics); and a customized uniform resource locator (“URL”) or website address to allow a user to easily return to the list if desired.

It may be an object of one aspect of the present invention to provide a system, method, and/or computer readable medium that publishes links to a REPCS-provider website using online advertisements whereby the system receives pass-through data from search engine terms and pay-per-click search engine advertisements, or other referral URLs.

It may be an object of one aspect of the present invention to provide a system, method, and/or computer readable medium that reads users' keywords from referral URLs to query property data.

It may be an object of one aspect of the present invention to provide a system, method, and/or computer readable medium that intelligently generates a list for any location, on demand, and upon receipt of search criteria sourced from a link to a REPCS-provider's website such that: (i) there is no need for a user to fill out a search form on the REPCS website; and (ii) there is no requirement on an REPCS-provider to anticipate and/or prepare saved search criteria.

It may be an object of one aspect of the present invention to provide a system, method, and/or computer readable medium that analyzes details of a specific property and/or intelligently generates a list of similar properties, preferably without having to pre-select a list of similar properties.

It may be an object of one aspect of the present invention to provide a system, method, and/or computer readable medium that analyzes details of a specific property and/or intelligently generates a list of similar properties automatically, with reference to home type, location, number of beds/baths, square footage, list price, other user activity.

It may be an object of one aspect of the present invention to provide a system, method, and/or computer readable medium that analyzes details of a specific property and/or intelligently generates a list of similar properties that automatically determines a range to select similar properties.

It may be an object of one aspect of the present invention to provide a system, method, and/or computer readable medium that when user input is received from a mobile device, takes account of the location data/information.

It may be an object of one aspect of the present invention to provide a system, method, and/or computer readable medium that uses any available zipcodes or other geocodes and consults/queries map databases to determine geo-codes and known boundaries for neighborhoods, and surveys surrounding areas, to present a user with a link to properties in a larger/expanded community area than was initially sought.

It may be an object of one aspect of the present invention to provide a system, method, and/or computer readable medium to store limits (in its internal rules system) on the size of the search area/location.

It may be an object of one aspect of the present invention to provide a system, method, and/or computer readable medium that conducts statistical calculations to, for example, serve a list of available homes in a particular area with a list price below / above a pre-determined percentile for that area.

It may be an object of one aspect of the present invention to provide a system, method, and/or computer readable medium that generates a list of properties similar to a particular reference property and/or repeatedly from time-to-time based on a pre-defined list statistical parameters of interest.

It may be an object of one aspect of the present invention to provide a system, method, and/or computer readable medium that conducts the following statistical calculations, among others: (i) distribution analysis to create property data selection ranges; (ii) property prices; (iii) inventory statistics; (iv) market activity; (v) most common and/or typical property type in an area; and/or (vi) median and/or average number of bedrooms and bathrooms.

It may be an object of one aspect of the present invention to provide a system, method, and/or computer readable medium to provide properties marked as “featured” that appear first on resulting lists and/or in a conspicuous location on served page of listings.

It may be an object of one aspect of the present invention to provide a system, method, and/or computer readable medium that automatically creates and customizes current real estate market condition reports based on user inputs, and affords automatic creation of comparison reports for neighboring, expanded, and more specific areas.

It may be an object of one aspect of the present invention to provide a system, method, and/or computer readable medium to provide reports that include data concerning: property prices; inventory statistics; market activity; most common and typical property type in an area; and/or median and average numbers of bedrooms and bathrooms.

It may be an object of one aspect of the present invention to provide a system, method, and/or computer readable medium to dynamically generate a URL for the hot list output, preferably one which may allow a user to revisit the list at a future time.

It may be an object of one aspect of the present invention to provide a system, method, and/or computer readable medium that is adapted to profile leads with records showing which properties have been marked as favorites, the types of properties viewed, and/or searches performed.

It may be an object of one aspect of the present invention to provide a system, method, and/or computer readable medium that follows-up with registered users with: new listings matching the lead's search criteria; updated market currents and REPCS-provider commentary and a call-to-action; and additional information based on the lead profile and/or activity.

It may be an object of one aspect of the present invention to provide a system, method, and/or computer readable medium adapted to integrate with online classified systems, online advertisement systems, and/or online social media systems, for example, the Craigslist system, the Google AdWords system, and the Facebook system.

It may be an object of one aspect of the present invention to provide a system, method, and/or computer readable medium adapted to allow advertisement links accessed by users to automatically serve intelligently generated dynamic lists.

It may be an object of one aspect of the present invention to provide a system, method, and/or computer readable medium adapted to include links to automatically serve intelligently generated dynamic lists of similar properties for static property listings reached by certain advertising links.

It may be an object of one aspect of the present invention to provide a system, method, and/or computer readable medium adapted to apply the meta data and advertising information from a referral URL to search real estate property data.

It may be an object of one aspect of the present invention to provide a system, method, and/or computer readable medium adapted to apply location information to search real estate property data.

It may be an object of one aspect of the present invention to apply a specific user's history and/or data collected from previous real estate searches to search real estate property data.

Prior attempts, if any, to solve problems associated with prior art systems, methods and/or computer readable media may have been unsuccessful and/or had one or more disadvantages associated with them. Prior art systems, methods and/or computer readable media may have been ill-suited to solve the stated problems and/or the shortcomings which have been associated with them.

It is an object of the present invention to obviate or mitigate one or more of the aforementioned disadvantages and/or shortcomings associated with the prior art, to provide one of the aforementioned needs or advantages, and/or to achieve one or more of the aforementioned objects of the invention.

### SUMMARY OF THE INVENTION

According to the invention, there is disclosed a system for use with one or more databases and with a real estate advertisement selected by a user after presentation by a search engine in response to input from the user. The system includes a search engine subsystem which receives, from the search engine, real estate pass-through data that includes the input from the user. The system also includes a database subsystem which sends a real estate hotlist query to the databases and, in response, receives real estate property listing data and market information from the databases. The system also includes a knowledge interpretation subsystem which automatically determines predefined information that corresponds with each . aforesaid real estate advertisement. Based on the predefined information and based on the real estate pass-through data, the knowledge interpretation subsystem automatically determines the real estate hotlist query. It thereby determines the real estate property listing data and the market information to be received from the databases for presentation to the user. Also based on the predefined information and based on the real estate pass-through data, the knowledge interpretation subsystem automatically processes the real estate property listing data and the market information to determine a real estate hotlist output for presentation to the user. In this manner, the system uses the real estate advertisement and the input from the user to automatically determine and process the real estate property listing data and the market information for presentation to the user.

According to an aspect of one preferred embodiment of the invention, the real estate pass-through data may preferably, but need not necessarily, also include location data associated with the user. The knowledge interpretation subsystem may preferably, but need not necessarily, automatically process at least one of (a) the real estate property listing data, and/or (b) the market information, preferably to determine comparative data. The comparative data may preferably, but need not necessarily, compare the location data and/or the input for presentation to the user as part of the real estate hotlist output.

According to an aspect of one preferred embodiment of the invention, the real estate pass-through data may preferably, but need not necessarily, also include: device data associated with the user; operating system data associated with the user; and/or originating uniform resource locator (e.g., website) data associated with said user.

According to an aspect of one preferred embodiment of the invention, the system may preferably, but need not necessarily, be adapted for use with a regional real estate property listing database among the databases.

According to an aspect of one preferred embodiment of the invention, the system may preferably, but need not necessarily, be adapted for use with a real estate professional's property listing database among the databases.

According to an aspect of one preferred embodiment of the invention, the knowledge interpretation subsystem may preferably, but need not necessarily, automatically—preferably based on the predefined information and/or based on the real estate pass-through data—process at least one of (a) the real estate property listing data, and/or (b) the market information, preferably to determine market statistics for presentation to the user as part of the real estate hotlist output.

According to an aspect of one preferred embodiment of the invention, the knowledge interpretation subsystem may preferably, but need not necessarily, automatically—preferably based on the predefined information and/or based on the real estate pass-through data—process at least one of (a) the real estate property listing data, and/or (b) the market information, preferably to determine one or more market reports for presentation to the user as part of the real estate hotlist output. The market reports may preferably, but need not necessarily, include one or more of: property prices, inventory statistics, market activity, one or more most prevalent real estate property types in a selected geographical region, and/or an enumeration of bedrooms and/or bathrooms in the most prevalent property types in the selected geographical region.

According to an aspect of one preferred embodiment of the invention, the knowledge interpretation subsystem may preferably, but need not necessarily, automatically perform one or more quantitative, semi-quantitative and/or statistical analyses of the input from the user preferably to, as aforesaid, determine the real estate hotlist query. It may preferably, but need not necessarily, thereby determine the real estate property listing data and/or the market information, preferably for presentation to the user.

According to an aspect of one preferred embodiment of the invention, the analyses may preferably, but need not necessarily, include one or more of: a real estate statistics distribution analysis; a statistical real estate property price analysis; a real estate inventory statistics analysis; a real estate market activity statistics analysis; an assessment of one or more most prevalent real estate property types in a selected geographical region; and/or an enumeration of bedrooms and/or bathrooms in the most prevalent property types in the selected geographical region.

According to an aspect of one preferred embodiment of the invention, the system may preferably, but need not necessarily, also include a unique uniform resource locator associated with the real estate hotlist output, preferably for selective return of the user to the real estate hotlist output.

According to an aspect of one preferred embodiment of the invention, the system may preferably, but need not necessarily, also include at least one system database. The predefined information may preferably, but need not necessarily, include metadata, stored in the system database, corresponding to each aforesaid real estate advertisement.

According to an aspect of one preferred embodiment of the invention, the knowledge interpretation subsystem may preferably, but need not necessarily, automatically—preferably based on a comparison of the input from the user and/or the real estate advertisement presented by the search engine in response thereto—determine the real estate hotlist query as aforesaid.

According to an aspect of one preferred embodiment of the invention, the comparison may preferably, but need not necessarily, include an analysis of any partial and/or exact matches between the input and/or the predefined information corresponding with the real estate advertisement.

According to an aspect of one preferred embodiment of the invention, the knowledge interpretation subsystem may preferably, but need not necessarily, automatically—preferably based on a first one or more of the real estate property listing data selected by the user—redetermine the real estate hotlist query. It may preferably, but need not necessarily, thereby redetermine a second one of more of the real estate property listing data to be received from the databases, preferably for presentation to the user.

According to an aspect of one preferred embodiment of the invention, the system may preferably, but need not necessarily, be adapted for use with a geographic database among the databases. The knowledge interpretation subsystem may preferably, but need not necessarily, automatically—based on the real estate pass-through data: determine one or more geo-codes and/or boundaries of a first neighborhood which may preferably, but need not necessarily, be associated with the real estate hotlist query of the databases; redetermine one or more real estate follow-up queries which may preferably, but need not necessarily, be associated with a second neighborhood surrounding, bounding and/or within the first neighborhood; and thereby redetermine the real estate property listing data and/or the market information to be received from the databases, preferably for presentation to the user.

According to an aspect of one preferred embodiment of the invention, preferably in processing the real estate property listing data to determine the real estate hotlist output as aforesaid, the knowledge interpretation subsystem may preferably, but need not necessarily, automatically identify one or more featured ones of the real estate property listing data, preferably for presentation to the user in a conspicuous location on the real estate hotlist output.

According to an aspect of one preferred embodiment of the invention, the knowledge interpretation subsystem may preferably, but need not necessarily, automatically determine a user profile associated with the user. The user profile may preferably, but need not necessarily, include one or more of: the real estate hotlist output determined for presentation to the user; the real estate property listing data selected by the user; the real estate property listing data viewed by the user; and/or the input from the user.

According to an aspect of one preferred embodiment of the invention, periodically, the knowledge interpretation subsystem may preferably, but need not necessarily, automatically—preferably based on the user profile—redetermine the real estate hotlist query and/or thereby redetermine one or more of (i) the real estate property listing data, and/or (ii) the market information, preferably for sending to the user.

According to an aspect of one preferred embodiment of the invention, preferably after each selection of the aforesaid real estate advertisement by the user, the knowledge interpretation subsystem may preferably, but need not necessarily, dynamically determine the real estate hotlist output, preferably as aforesaid, and preferably based on the pass-through data including the input from the user.

According to an aspect of one preferred embodiment of the invention, the knowledge interpretation subsystem may preferably, but need not necessarily, automatically—preferably based on the predefined information and/or based on the real estate pass-through data—processes the real estate property listing data and/or the market information to determine the real estate hotlist output, preferably at least in part in the form of a visual representation, and preferably for presentation to said user.

According to an aspect of one preferred embodiment of the invention, the visual representation may preferably, but need not necessarily, include one or more of: a graphic representation of the real estate property listing data and/or the market information; an info-graphic representation of the real estate property listing data and/or the market information; a map representation of the real estate property listing data and/or the market information; a video representation of the real estate property listing data and/or the market information; and/or an audiovisual representation of the real estate property listing data and/or the market information.

According to the invention, there is also disclosed a method for use with one or more databases and with a real estate advertisement selected by a user after presentation by a search engine in response to input from the user. The method includes step (a) of receiving, from the search engine, real estate pass-through data that includes the input from the user. The method also includes step (b) of sending a real estate hotlist query to the databases and, in response, receiving real estate property listing data and market information from the databases. The method also includes step (c) of automatically determining predefined information that corresponds with each aforesaid real estate advertisement and, based on the predefined information and based on the real estate pass-through data, automatically: (i) determining the real estate hotlist query and thereby determining the real estate property listing data and the market information to be received from the databases for presentation to the user; and (ii) processing the real estate property listing data and the market information to determine a real estate hotlist output for presentation to the user. In this manner, the method uses the real estate advertisement and the input from the user to automatically determine and process the real estate property listing data and the market information for presentation to the user.

According to an aspect of one preferred embodiment of the invention, preferably in step (a), the real estate pass-through data may preferably, but need not necessarily, also include location data associated with the user. The method may preferably, but need not necessarily, also include, preferably in step (c), automatically processing at least one of the real estate property listing data, and/or the market information, to determine comparative data. The comparative data may preferably, but need not necessarily, compare the location data and/or the input, preferably for presentation to the user as part of the real estate hotlist output.

According to an aspect of one preferred embodiment of the invention, preferably in step (a), the real estate pass-through data may preferably, but need not necessarily, also include: device data associated with the user; operating system data associated with the user; and/or originating uniform resource locator (e.g., website) data associated with said user.

According to an aspect of one preferred embodiment of the invention, the method may preferably, but need not necessarily, be adapted for use, preferably in step (b), with a regional real estate property listing database among the databases.

According to an aspect of one preferred embodiment of the invention, the method may preferably, but need not necessarily, be adapted for use, preferably in step (b), with a real estate professional's property listing database among the databases.

According to an aspect of one preferred embodiment of the invention, the method may preferably, but need not necessarily, also include, preferably in step (c) and/or based on the predefined information and/or based on the real estate pass-through data, automatically processing at least one of the real estate property listing data, and/or the market information, preferably to determine market statistics preferably for presentation to the user as part of the real estate hotlist output.

According to an aspect of one preferred embodiment of the invention, the method may preferably, but need not necessarily, also include, preferably in step (c) and/or based on the predefined information and/or based on the real estate pass-through data, automatically processing at least one of the real estate property listing data, and/or the market information, preferably to determine one or more market reports preferably for presentation to the user as part of the real estate hotlist output. The market reports may preferably, but need not necessarily, include one or more of: property prices, inventory statistics, market activity, one or more most prevalent real estate property types in a selected geographical region, and/or an enumeration of bedrooms and/or bathrooms in the most prevalent property types in the selected geographical region.

According to an aspect of one preferred embodiment of the invention, preferably in step (c), one or more quantitative, semi-quantitative and/or statistical analyses of the input from the user may preferably, but need not necessarily, be automatically performed to, preferably as aforesaid, determine the real estate hotlist query and/or thereby determine the real estate property listing data and/or the market information, preferably for presentation to the user.

According to an aspect of one preferred embodiment of the invention, the analyses may preferably, but need not necessarily, include one or more of: a real estate statistics distribution analysis; a statistical real estate property price analysis; a real estate inventory statistics analysis; a real estate market activity statistics analysis; an assessment of one or more most prevalent real estate property types in a selected geographical region; and/or an enumeration of bedrooms and/or bathrooms in the most prevalent property types in the selected geographical region.

According to an aspect of one preferred embodiment of the invention, the method may preferably, but need not necessarily, also include generating a unique uniform resource locator in association with the real estate hotlist output, preferably for selective return of the user to the real estate hotlist output.

According to an aspect of one preferred embodiment of the invention, the method may preferably, but need not necessarily, also include providing at least one system database. Preferably in step (c), the predefined information may preferably, but need not necessarily, includes metadata, preferably stored in the system database, and preferably corresponding to each aforesaid real estate advertisement.

According to an aspect of one preferred embodiment of the invention, preferably in step (c), the real estate hotlist query may preferably, but need not necessarily, be automatically determined, preferably based on a comparison of the input from the user and/or the real estate advertisement presented by the search engine in response thereto.

According to an aspect of one preferred embodiment of the invention, preferably in step (c), the comparison may preferably, but need not necessarily, include an analysis of any partial and/or exact matches between the input and/or the predefined information corresponding with the real estate advertisement.

According to an aspect of one preferred embodiment of the invention, the method may preferably, but need not necessarily, also include, preferably in step (c), automatically redetermining the real estate hotlist query, preferably based on a first one or more of the real estate property listing data selected by the user, and/or preferably thereby redetermining a second one of more of the real estate property listing data, preferably to be received from the databases and preferably for presentation to the user.

According to an aspect of one preferred embodiment of the invention, the method may preferably, but need not necessarily, be adapted for use, preferably in step (b), with a geographic database among the databases. The method may preferably, but need not necessarily, also includes, preferably in step (c), automatically: determining one or more geo-codes and/or boundaries of a first neighborhood associated with the real estate hotlist query of the databases, preferably based on the real estate pass-through data; redetermining one or more real estate follow-up queries associated with a second neighborhood surrounding, bounding and/or within the first neighborhood; and/or preferably thereby redetermining the real estate property listing data and/or the market information, preferably to be received from the databases and preferably for presentation to the user.

According to an aspect of one preferred embodiment of the invention, the method may preferably, but need not necessarily, also include, preferably in step (c)(ii), automatically identifying one or more featured ones of the real estate property listing data, preferably for presentation to the user in a conspicuous location on the real estate hotlist output.

According to an aspect of one preferred embodiment of the invention, the method may preferably, but need not necessarily, also include, preferably in step (c), automatically determining a user profile associated with the user. The user profile may preferably, but need not necessarily, include of one or more of: the real estate hotlist output determined for presentation to the user; the real estate property listing data selected by the user; the real estate property listing data viewed by the user; and/or the input from the user.

According to an aspect of one preferred embodiment of the invention, the method may preferably, but need not necessarily, also includes, preferably in step (c), periodically and/or automatically: redetermining the real estate hotlist query, preferably based on the user profile; and/or preferably thereby redetermining one or more of the real estate property listing data, and/or the market information, preferably for sending to the user.

According to an aspect of one preferred embodiment of the invention, the method may preferably, but need not necessarily, also include, preferably in step (c) and/or after each selection of the aforesaid real estate advertisement by the user, dynamically determining the real estate hotlist output, preferably as aforesaid, and preferably based on the pass-through data including the input from the user. According to an aspect of one preferred embodiment of the invention, in step (c)(ii), the real estate property listing data and/or the market information may preferably, but need not necessarily, be processed to determine the real estate hotlist output, preferably at least in part in the form of a visual representation, and preferably for presentation to said user.

According to an aspect of one preferred embodiment of the invention, in step (c)(ii), the visual representation may preferably, but need not necessarily, include one or more of: a graphic representation of the real estate property listing data and/or the market information; an info-graphic representation of the real estate property listing data and/or the market information; a map representation of the real estate property listing data and/or the market information; a video representation of the real estate property listing data and/or the market information; and an audiovisual representation of the real estate property listing data and/or the market information.

According to the invention, there is also disclosed a computer readable medium for use with one or more databases and with a real estate advertisement selected by a user after presentation by a search engine in response to input from the user. The computer readable medium is encoded with executable instructions to, when executed, encode one or more processors to automatically perform the steps of: (a) receiving, from the search engine, real estate pass-through data that includes the input from the user; (b) sending a real estate hotlist query to the databases and, in response, receiving real estate property listing data and market information from the databases; and (c) automatically determining predefined information that corresponds with each aforesaid real estate advertisement and, based on the predefined information and based on the real estate pass-through data, automatically: (i) determining the real estate hotlist query and thereby determining the real estate property listing data and the market information to be received from the databases for presentation to the user; and (ii) processing the real estate property listing data and the market information to determine a real estate hotlist output for presentation to the user. In this manner, computer readable medium and the executable instructions encode the processors to use the real estate advertisement and the input from the user to automatically determine and process the real estate property listing data and the market information for presentation to the user.

According to an aspect of one preferred embodiment of the invention, the executable instructions, preferably when executed, may preferably, but need not necessarily, further encode the processors to: preferably in step (a), receive location data associated with the user, preferably as part of the real estate pass-through data; and preferably in step (c), automatically process at least one of the real estate property listing data, and/or the market information, preferably to determine comparative data. The comparative data may preferably, but need not necessarily, compare the location data and/or the input, preferably for presentation to the user as part of the real estate hotlist output.

According to an aspect of one preferred embodiment of the invention, the executable instructions, preferably when executed, may preferably, but need not necessarily, further encode the processors to receive, preferably in step (a) and/or as part of the real estate pass-through data: device data associated with the user; operating system data associated with the user; and/or originating uniform resource locator (e.g., website) data associated with said user.

According to an aspect of one preferred embodiment of the invention, the executable instructions, preferably when executed, may preferably, but need not necessarily, further encode the processors for use, preferably in step (b), with a regional real estate property listing database among the databases.

According to an aspect of one preferred embodiment of the invention, the executable instructions, preferably when executed, may preferably, but need not necessarily, further encode the processors for use, preferably in step (b), with a real estate professional's property listing database among the databases.

According to an aspect of one preferred embodiment of the invention, the executable instructions, preferably when executed, may preferably, but need not necessarily, further encode the processors to, preferably in step (c) and/or based on the predefined information and/or based on the real estate pass-through data, automatically process at least one of the real estate property listing data, and/or the market information, preferably to determine market statistics and preferably for presentation to the user as part of the real estate hotlist output.

According to an aspect of one preferred embodiment of the invention, the executable instructions, preferably when executed, further encode the processors to, preferably in step (c) and/or based on the predefined information and/or based on the real estate pass-through data, automatically process at least one of the real estate property listing data, and/or the market information, preferably to determine one or more market reports and preferably for presentation to the user as part of the real estate hotlist output. The market reports may preferably, but need not necessarily, include one or more of: property prices, inventory statistics, market activity, one or more most prevalent real estate property types in a selected geographical region, and/or an enumeration of bedrooms and/or bathrooms in the most prevalent property types in the selected geographical region.

According to an aspect of one preferred embodiment of the invention, the executable instructions, preferably when executed, may preferably, but need not necessarily, further encode the processors to, preferably in step (c), automatically perform one or more quantitative, semi-quantitative and/or statistical analyses of the input from the user to, preferably as aforesaid, determine the real estate hotlist query and/or preferably thereby determine the real estate property listing data and/or the market information, preferably for presentation to the user.

According to an aspect of one preferred embodiment of the invention, the executable instructions, preferably when executed, may preferably, but need not necessarily, further encode the processors such that the analyses preferably include one or more of: a real estate statistics distribution analysis; a statistical real estate property price analysis; a real estate inventory statistics analysis; a real estate market activity statistics analysis; an assessment of one or more most prevalent real estate property types in a selected geographical region; and/or an enumeration of bedrooms and/or bathrooms in the most prevalent property types in the selected geographical region.

According to an aspect of one preferred embodiment of the invention, the executable instructions, preferably when executed, may preferably, but need not necessarily, further encode the processors to generate a unique uniform resource locator in association with the real estate hotlist output, preferably for selective return of the user to the real estate hotlist output.

According to an aspect of one preferred embodiment of the invention, the executable instructions, preferably when executed, may preferably, but need not necessarily, further encode the processors to retrieve preferably from at least one system database, preferably in step (c), metadata corresponding to each aforesaid real estate advertisement preferably as at least a part of the predefined information.

According to an aspect of one preferred embodiment of the invention, the executable instructions, preferably when executed, may preferably, but need not necessarily, further encode the processors to, preferably in step (c), automatically determine the real estate hotlist query preferably based on a comparison of the input from the user and/or the real estate advertisement presented by the search engine in response thereto.

According to an aspect of one preferred embodiment of the invention, the executable instructions, preferably when executed, may preferably, but need not necessarily, further encode the processors such that, preferably in step (c), the comparison preferably includes an analysis of any partial and/or exact matches between the input and/or the predefined information corresponding with the real estate advertisement.

According to an aspect of one preferred embodiment of the invention, the executable instructions, preferably when executed, may preferably, but need not necessarily, further encode the processors to, preferably in step (c), automatically: redetermine the real estate hotlist query preferably based on a first one or more of the real estate property listing data selected by the user; and/or preferably thereby redetermine a second one of more of the real estate property listing data to be received from the databases, preferably for presentation to the user.

According to an aspect of one preferred embodiment of the invention, the executable instructions, preferably when executed, may preferably, but need not necessarily, further encode the processors for use, preferably in step (b), with a geographic database among the databases and/or, preferably in step (c), to automatically: determine one or more geo-codes and/or boundaries of a first neighborhood associated with the real estate hotlist query of the databases preferably based on the real estate pass-through data; redetermine one or more real estate follow-up queries associated with a second neighborhood preferably surrounding, bounding and/or within the first neighborhood; and/or preferably thereby redetermine the real estate property listing data and/or the market information to be received from the databases, preferably for presentation to the user.

According to an aspect of one preferred embodiment of the invention, the executable instructions, preferably when executed, may preferably, but need not necessarily, further encode the processors to, preferably in step (c)(ii), automatically identify one or more featured ones of the real estate property listing data, preferably for presentation to the user in a conspicuous location on the real estate hotlist output.

According to an aspect of one preferred embodiment of the invention, the executable instructions, preferably when executed, may preferably, but need not necessarily, further encode the processors to, preferably in step (c), automatically determine a user profile, associated with the user, which preferably includes one or more of: the real estate hotlist output determined for presentation to the user; the real estate property listing data selected by the user; the real estate property listing data viewed by the user; and/or the input from the user.

According to an aspect of one preferred embodiment of the invention, the executable instructions, preferably when executed, may preferably, but need not necessarily, further encode the processors to, preferably in step (c), periodically and/or automatically: redetermine the real estate hotlist query preferably based on the user profile; and/or preferably thereby redetermine one or more of the real estate property listing data, and/or the market information, preferably for sending to the user.

According to an aspect of one preferred embodiment of the invention, the executable instructions, preferably when executed, may preferably, but need not necessarily, further encode the processors to, preferably in step (c) and/or after each selection of the aforesaid real estate advertisement by the user, dynamically determine the real estate hotlist output, preferably as aforesaid, and preferably based on the pass-through data including the input from the user.

According to an aspect of one preferred embodiment of the invention, the executable instructions, preferably when executed, may preferably, but need not necessarily, further encode the processors to, preferably in step (c)(ii), process the real estate property listing data and/or the market information to determine the real estate hotlist output preferably at least in part in the form of a visual representation and preferably for presentation to said user.

According to an aspect of one preferred embodiment of the invention, the executable instructions, preferably when executed, may preferably, but need not necessarily, further encode the processors such that, preferably in step (c)(ii), the visual representation may preferably, but need not necessarily, include one or more of: a graphic representation of the real estate property listing data and/or the market information; an info-graphic representation of the real estate property listing data and/or the market information; a map representation of the real estate property listing data and/or the market information; a video representation of the real estate property listing data and/or the market information; and an audiovisual representation of the real estate property listing data and/or the market information.

Other advantages, features and/or characteristics of the present invention, as well as methods of operation and/or functions of the related elements of the device, system, method and computer readable medium, and/or the combination of steps, parts and/or economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method and computer readable medium according to the present invention, as to their structure, organization, use, and/or method of operation, together with further objectives and/or advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram depicting a real estate property content system according to one preferred embodiment of the invention;

FIG. 2 is a flowchart of a method of generating a hot list from referral URL according to a preferred embodiment of the invention;

FIG. 3 is a flowchart of a method of selecting similar properties given property data for a specific property;

FIG. 4 is a flowchart of a method of selecting additional property data over an expanded area;

FIG. 5 is a flowchart of statistical calculations on property data;

FIG. 6 is a home page of a REPCS-provider website of the system of FIG. 1;

FIG. 7 is a guide page of a REPCS-provider website of the system of FIG. 1;

FIG. 8 is a hot lists static page of a REPCS-provider website of the system of FIG. 1;

FIG. 9 is a hot lists intelligent page of a REPCS-provider website of the system of FIG. 1;

FIG. 10 is a grid view of a REPCS-provider website of the system of FIG. 1;

FIG. 11 is a map view of a REPCS-provider website of the system of FIG. 1;

FIG. 12 is a user registration form of a REPCS-provider website of the system of FIG. 1;

FIG. 13 is a MyLeads integration window for a REPCS-provider in accordance with the system of FIG. 1;

FIG. 14 is an ongoing email follow-up for a REPCS-provider and a user in accordance with the system of FIG. 1;

FIG. 15 is a realtor credibility window for a REPCS-provider and a user in accordance with the system of FIG. 1;

FIG. 16 is a Craigslist integration window of the system of FIG. 1; and

FIG. 17 is an AdWords integration window of the system of FIG. 1.

### DETAILED DESCRIPTION OF THE PREFERRED EMBODIMENTS

A real estate property content system (“REPCS”) 100 according to the present invention may preferably comprise a software application (not shown) for selecting, manipulating and/or displaying real estate property data 190 and/or related informational content (alternately, hereinafter, “market information”) 160 for users of an REPCS-provider's website 102,104,106,108.

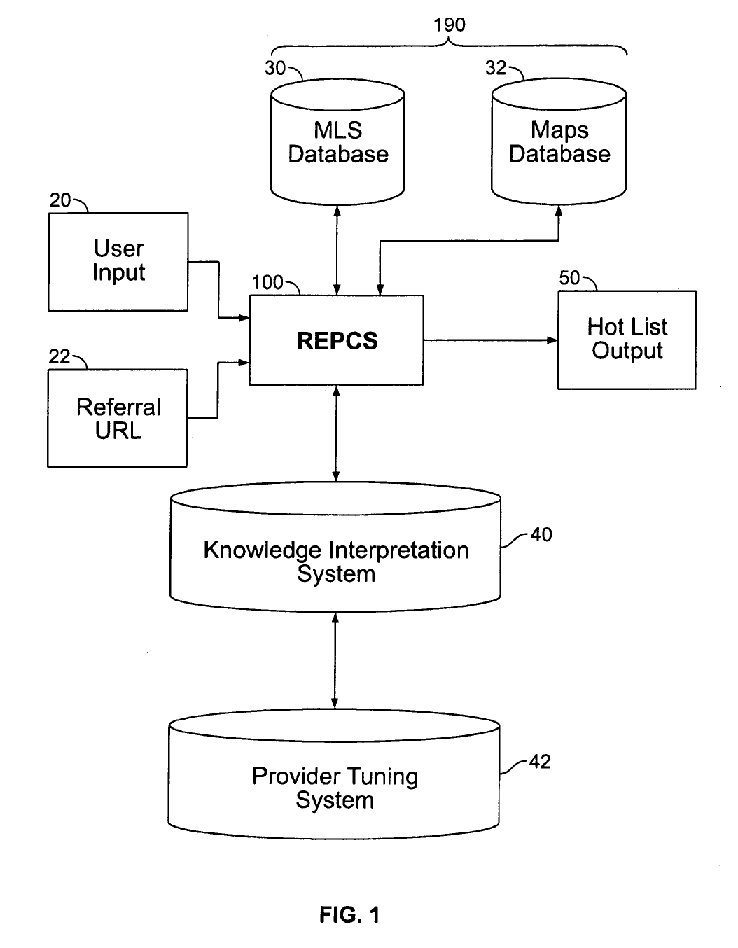

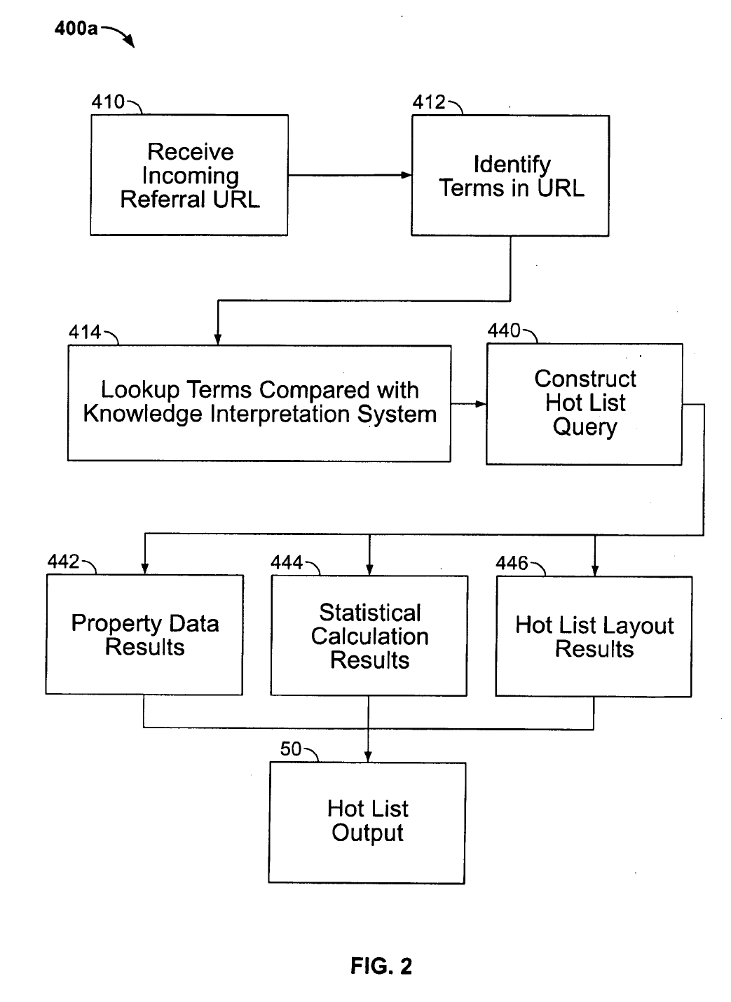

Referring to FIG. 1, there is generally depicted a schematic diagram of a system 100 according to a preferred embodiment of the present invention. A user input (e.g., whether through a search form, links on an REPCS-provider's website 102,104,106,108, native searches, online advertisements, and/or otherwise) 20 and/or a referral URL (“uniform resource locator”; e.g., from search engine outputs or online advertisements) 22 is received by the system 100 from a referral website (not shown). The system 100 consults a knowledge interpretation system 40, which may comprise definitions, rules and/or layouts for reading the user input 20 and/or the referral URL 22 to construct a hot list query (as described in FIG. 2) for searching real estate property data 190 residing in a MLS database 30 and/or a maps database 32 (includes location information 152).

As used herein, and where appropriate, “hot list” may be used interchangeably with “real estate hot list” (e.g., as in real estate hot list query or real estate hotlist output) and may refer, among other things, to one or more lists of favorite real estate property listing data and/or market information, and/or to one or more items of real estate property listing data and/or market information best matching the real estate pass-through data, the real estate input from the user, and/or the pre-defined information associated with and/or corresponding to the advertisements.

A hot list output 50 is generated based on the search. Provider tuning system 42, which comprises alternate or additional rules, featured properties, and complements and/or supplements the knowledge interpretation system 40.

In addition, however, the system, method and computer readable medium according to the present invention may preferably also use the knowledge interpretation system 40 to perform the refinement process for the user, helping to arrive at a desired list of property information with less direct user input 20 or manipulation. According to the invention, users can be linked directly to an intelligently-generated hot list through native search results and/or through online advertisements (“ads”) (e.g., pay-per-click search engine ads, banner ads, or Craigslist ads proffered by Craigslist, Inc. of San Francisco, Calif.).

Notably, property data 190 may preferably, but need not necessarily, include: (i) real estate property listings sourced from a regional database (e.g., a MLS database 30 licensed by The Canadian Real Estate Association of Ottawa, Ontario); (ii) listings published by a real estate professional 110 acting as an REPCS-provider (hereinafter used interchangeably with “real estate professional”); (iii) listings from other database sources (not show); and/or (iv) real estate market information 160 (which may include, among others, related informational content such as market statistics and/or reports).

According to FIG. 1, the system 100 of a preferred embodiment of the present invention may preferably parse the user input 20 and/or referral URL 22 by consulting the knowledge interpretation system 40 (i.e., an internal system of rules and/or definitions) to intelligently. determine: (i) the property data 190 to select; (ii) any statistical calculations to be performed on that data (not shown); and (iii) appropriate webpage layouts for the hot list output 50. The system according to the present invention may preferably generate a hot list output 50 which may include: (a) property listing data (not shown) e.g., in the form of a list and/or for one specific property); (b) an intelligently-constructed web page layout with additional content (e.g., including market statistics, informative articles, and/or links to more information and/or to different hot lists); and/or (c) a customized URL or website address to allow the user to easily return to the list, if desired.

REPCS users may preferably choose from pre-defined sets of “hot list” criteria, or specify their own unique listing criteria using input forms, and then save these criteria for future use.

Thus the system, method and computer readable medium according to the present invention may preferably enable the list to be generated based on information sourced and/or passed through from search engines, including a combination of pre-defined information in an online advertisement (e.g., “free list of fixer-upper properties”), and any search terms (e.g., user input 20) entered by the user (e.g., “homes for sale Naperville”).

The pass-through data 20,22 received from the referral URL 22 should focus moreso on meta data and advertising information than the literal search terms themselves provided by the user. The information may consist of which advertisement 204 was clicked, and which keywords triggered the advertisement 204 (i.e., this process is not the same as the search terms as a whole). There may also be location data 150 (e.g., a northerner looking for Florida property.) Also, we may also get, depending on the search engine, information as to why/how the ad was triggered (i.e. Exact matches, partial matches and the relationship to the ad content).

Additional criteria based on user activity (e.g., user input 20, etc.) and/or data history (e.g., similarity to previous properties viewed, previous hot lists, and/or previous criteria).” may lead to an inference based on one specific user's history/data as provided by the knowledge interpretation system 40 and/or the provider tuning system 42. The system 100 can also use history/data aggregated from site information, regional information and in total.

In some instances, the relationship of the user input 20 and/or the referral URL 22 to the knowledge interpretation system 40 may be too narrow. For example, a user searches “<Region> Starter Home” and then selects an advertisement for 1-2 bedroom homes. If the <Region>=large city, the system 100 may have a hotlist output 50 that shows condo as the most appropriate result. Similarly, the regional data may indicate that a foreclosure list is the best results to display. Notably, the hot list output 50 is generated with none of the terms present in the referral URL 22 as search terms or as keywords.

The system 100 according to the present invention may preferably enable a user to quickly get to a refined list of properties, with very little additional input or interaction.

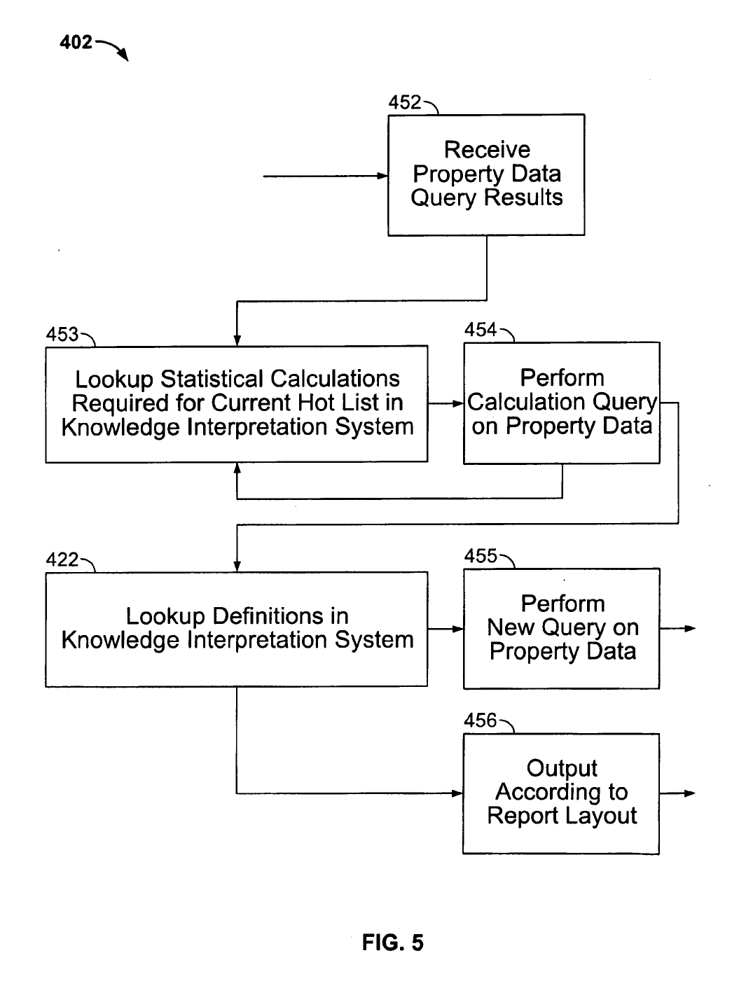

FIGS. 2 to 4 depict selected steps of a method 400a-c of using the referral URL 22 and/or specific property listing data 420 to generate the hot list output 50. FIG. 5 depicts steps of a method 402 of preparing a hotlist output 50 according a report layout using property data query results. In the description of the methods 400a-c, 402 which follow, the same reference numerals are used as those which are used with reference to the system 100. The methods 400a-c, 402 are suitable for use with the system 100 described herein and shown in FIG. 1, but it is not so limited.

As shown in FIG. 2, the method 400a includes the following steps, among others, to generate the hot list output 50 from the referral URL 22: a receive incoming referral URL step 410; an identify search terms in URL step 412; a lookup terms in knowledge interpretation system step 414; a construct hot list query step 440; up to three concurrent steps including a property data results step 442, a statistical calculation results step 444, and a hot list layout results step 446; resulting in the generation of the hot list output 50.

It will be appreciated that, according to the method 400a, search terms in the referral URL 22 may be identified due to the general structure of URLs known to persons having ordinary skill in the art. The rules and/or definitions provided by the lookup terms in the knowledge interpretation system step 422 provides the terms for the hot list query step 440.

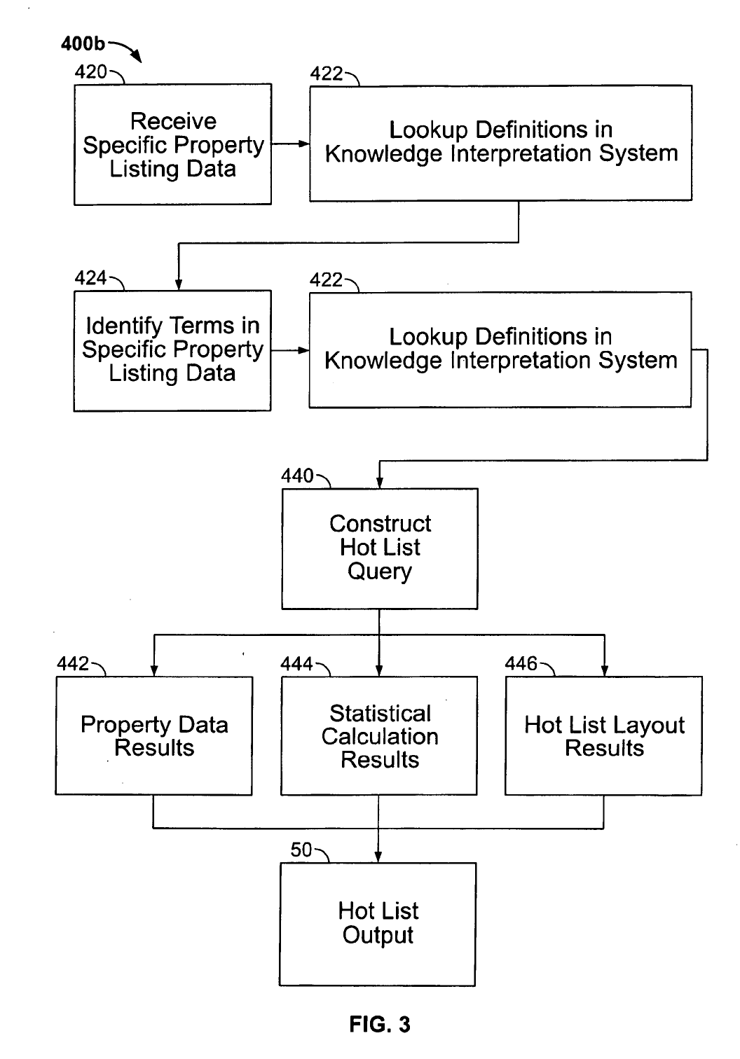

As shown in FIG. 3, the method 400b includes the following steps, among others, for using specific property listing data to select similar properties in the hot list output 50: a receive specific property listing data step 420; a lookup definitions in knowledge interpretation system step 422; an identify terms in specific property listing data step 424; a second lookup definitions in knowledge interpretation system step 422; a construct hot list query step 440; up to three concurrent steps including a property data results step 442, a statistical calculation results step 444, and a hot list layout results step 446; resulting in the generation of the hot list output 50.

It will be appreciated that, according to the method 400b, the rules defining the criteria for selecting “similar properties” from the first lookup definitions step 422 may be stored in the knowledge interpretation system step 422. Similarly, the rules defining the criteria for numerical range data (e.g., a price range, a square-footage range, etc.) in the second lookup definitions may also be stored in the knowledge interpretation system step 422.

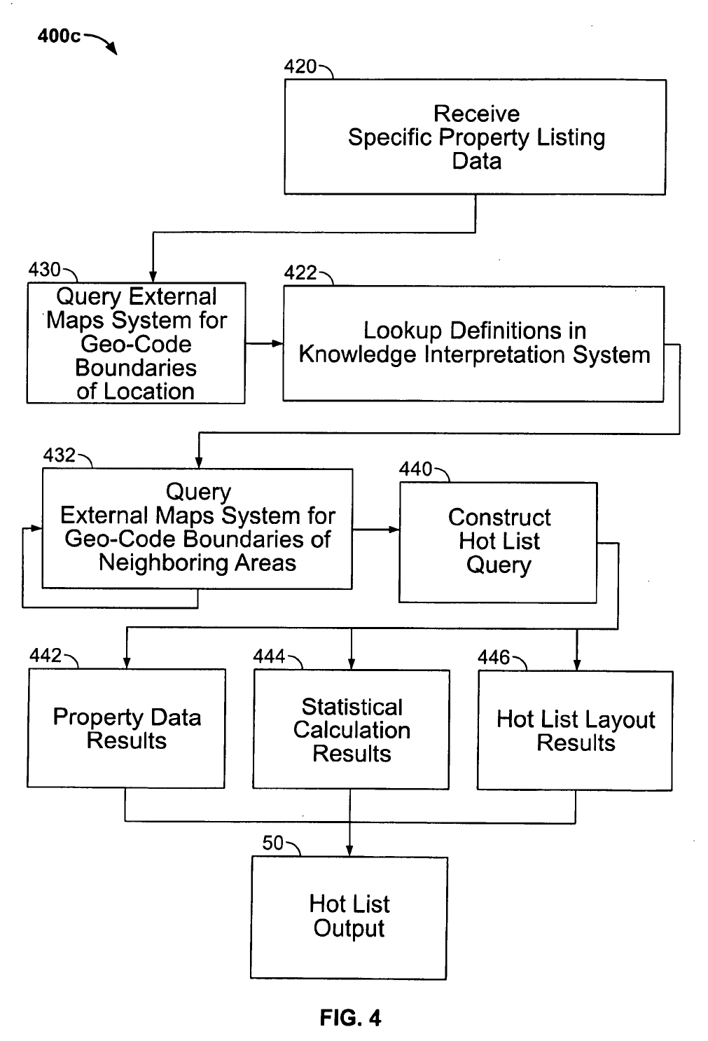

As shown in FIG. 4, the method 400c includes the following steps, among others, for the use of specific property listing data to select additional property data over an expanded location 150 for the hot list output 50: a receive specific property listing data step 420; a query external maps system for geo-code boundaries of location step 430; a lookup definitions in knowledge interpretation system step 422; a query external maps system for geo-code boundaries of neighboring areas step 432; a construct hot list query step 440; up to three concurrent steps including a property data results step 442, a statistical calculation results step 444, and a hot list layout results step 446; resulting in the generation of the hot list output 50.

It will be appreciated that, according to the method 400c, the receive specific property listing data step 452 may also include additional search criteria, such as neighborhood name and zip code. The lookup definitions in the knowledge interpretation system 422 includes neighboring geo-code boundaries and/or rules defining geo-code boundaries to search. Query external maps system for geo-code boundaries of neighboring areas step 432 is an iterative process based on definitions.

As shown in FIG. 5, the method 402 includes the following steps, among others, for performing statistical calculations on property data 190: a receive property data query results step 452; a lookup statistical calculations required for current hot list in knowledge interpretation step 453; a perform calculation query on property data step 454; a lookup definitions in knowledge interpretation system step 422; a perform new query on property data step 455; and/or an output according to report layout step 456.

It will be appreciated that, according to the method 402, the statistical calculations required for the current hot list 50 in the knowledge interpretation system step 453 includes definitions that provide the calculation methods. The definitions in the knowledge interpretation system step 422 include the generation of report layouts or property data selection queries depending on the desired result. At this stage, a new query may be performed on the property data step (e.g., subset of original query).

The system, method and computer readable medium according to the present invention may preferably comprise software code.

Increased Speed and Efficiency for the User in Locating their Desired Information

The present system preferably uses knowledge interpretation to anticipate a user's desired property listing criteria and/or to intelligently generate a hot list of properties with those criteria. This may preferably allow the user to be immediately and/or forthwith presented with a list of relevant information, preferably without having to fill out a search form on the REPCS website.

Example: The present system 100 may preferably receive pass-through data 20,22 from search engine terms and/or pay-per-click search engine advertisements 204. Suppose a user conducts a Google search (using the online search engine offered by Google Inc. of Mountain View, Calif.) for “condos for sale Chicago” and locates a pay-per-click (“PPC”) advertisement for an REPCS-provider's website 102,104,106,108. When the user clicks the advertisement to visit the website, the system 100 according to the present invention may preferably read coded information from the referral URL 22, interpret the input and use it to intelligently select, generate and/or present an on-demand list of condos for sale in the Chicago area. The user navigates directly from Google search results to the condo list without an intermediate step of filling out a search form on the REPCS-provider's website 102,104,106,108 specifying they're interested in condos and/or Chicago.

Technical Overview: Links from Google search results or other search engine results and ads may alternately be referenced herein to as referral URLs 22. Among other information, a referral URL 22 may preferably contain search keywords that a user entered to generate search results. The system 100 according to the present invention may preferably parse these keywords out of the referral URL 22, and/or compare them to an internal system of terms and/or rules to determine selection criteria for its property data query. Preferably, the result is that the user input 20 initially entered into the search engine may be automatically included in the process of selecting and/or displaying property data and/or content, preferably without the user being required to enter it again on a website search form. FIG. 2 provides a high-level diagram of this process.

### Increased Speed and Efficiency for REPCS-Providers in Presenting Information Without Having to Prepare Multiple Pre-Formatted Search Lists in Advance

As aforesaid, the system 100 according to the present invention may preferably use the knowledge interpretation system 40 to intelligently search, select and/or present the data. Preferably, REPCS-providers 110 may not be required to anticipate and/or prepare saved search criteria. This advantageous utility may preferably allow the REPCS-provider 110 to operate the system 100 according to the present invention with a minimum of interaction.

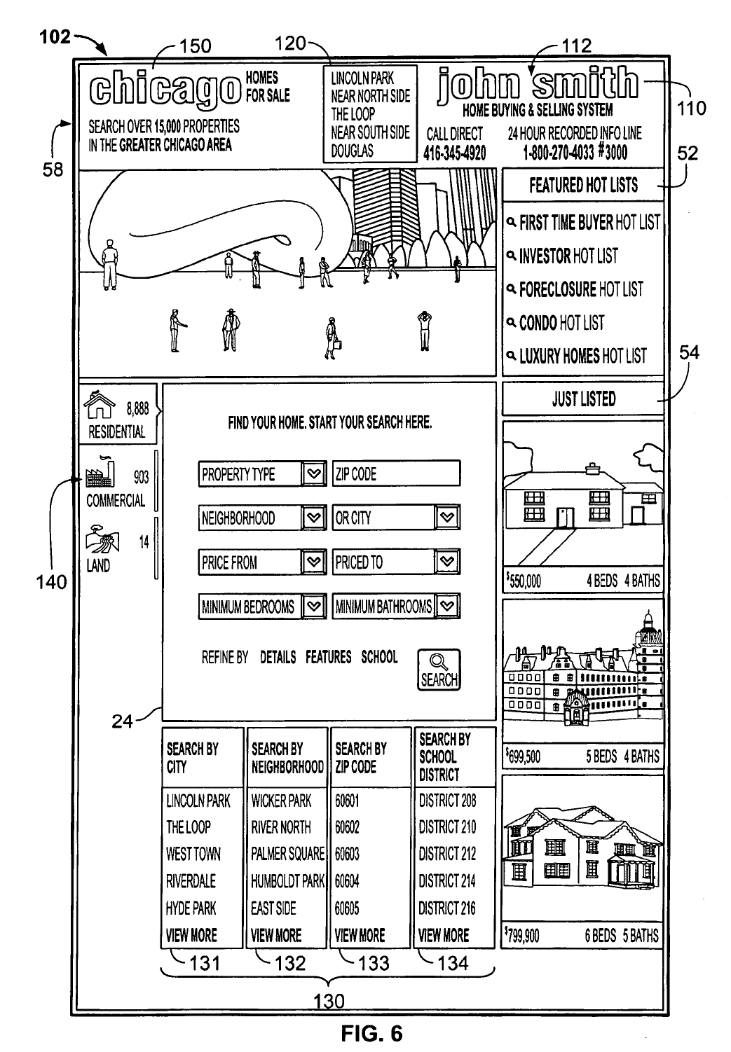

Example: Cartographers may Distinguish Between over Two Hundred neighborhoods and seventy seven community areas in the city of Chicago. According to the present invention, an REPCS-provider 110 may preferably not need to prepare a group of saved search criteria in every one of the locations 150—the system 100 according to the present invention may preferably intelligently generate a list for any area (alternately “location”) 150, preferably on demand, and preferably upon its receipt search criteria sourced from a link to the REPCS-provider's website 102,104,106,108. According to the present invention, and as shown in FIG. 6, the REPCS-provider 110 may simply publish links to their website in online advertisements. [Further information concerning location data selection may be discussed elsewhere herein, including in point (b) below.]

Technical Overview: The system according to the present invention may preferably read the users' search criteria 24 from the search engines' referral URLs 22. According to the present invention, it may no longer be necessary to create saved search criteria in advance. According to the present invention, the users' search criteria 24 may preferably be automatically taken into consideration. Furthermore, reading the users' keywords from the referral URLs 22 and using them to query property data may preferably, according to the present invention, allow for flexibility in the query process. For example, queries the REPCS-provider 110 may not have contemplated in advance may preferably be possible in use of the system 100 according to the present invention.

### Fuzzy Logic for Selection of Criteria and Appropriate Properties

### (a) Similar Properties Selection

The system 100 according to the present invention may preferably analyze the details of a specific property and/or intelligently generate a list of similar properties. According to the invention, REPCS-providers 110 may preferably promote one property with a link to “more homes like this”, preferably without having to pre-select a list of similar properties.

Example: When a user viewing the property details of a home clicks the “more homes like this” link, the system 100 according to the present invention may preferably automatically draw a number of criteria from the property details (e.g., home type, number of beds/baths, square footage, and/or list price). Preferably, the system 100 according to the present invention may use these to select and display more properties matching the criteria. Where one of the criteria is a number (e.g., square footage), the system 100 according to the present invention may preferably automatically determine a range to select similar properties (e.g., ±250 sq. ft. and/or using a more complex distributional analysis such as deviation from a value).

Possible criteria that could be used by the system 100 according to the present invention to select similar properties may preferably include one or more of the following: (a) Home type (e.g., single family, condo, and/or multi-family); (b) Location data (e.g., same neighborhood, adjoining neighborhoods, and/or within an area defined by geo-code boundaries); (c) Number of bedrooms and/or bathrooms; (d) Square footage (e.g., within a statistical range); and/or (d) Additional criteria based on user activity and/or data history (e.g., similarity to previous properties viewed, previous hot lists, and/or previous criteria).

Where a specific type of hot list output 50 requested is unknown and/or uncertain, the system 100 according to the present invention may preferably automatically make a “best guess” based on criteria and/or past history. The system 100, method and/or computer readable medium according to the present invention may preferably also and/or instead suggest links to other hot lists, which may be filtered and/or sorted differently.

Technical Overview: Preferably, the process of analyzing a specific property and/or generating a property data query may be achieved in at least two different ways according to the present invention. First, the similarity criteria that the property advertiser wishes to be used can be embedded in the referral URL 22 in the “more homes like this” link, which the system 100 according to the present invention may preferably read and/or use to generate the query. Second, given access to a property data feed for the specific property, the system 100 according to the present invention may preferably use knowledge interpretation system 40 to parse specific details out of the property data for use in the query. The rules system may preferably, according to the present invention, also be used to create statistical ranges for numerical properties. [See point (c) below and/or elsewhere herein for detail concerning statistical calculation.] FIG. 3 provides a high-level diagram of this process.

### (b) Location Data Selection

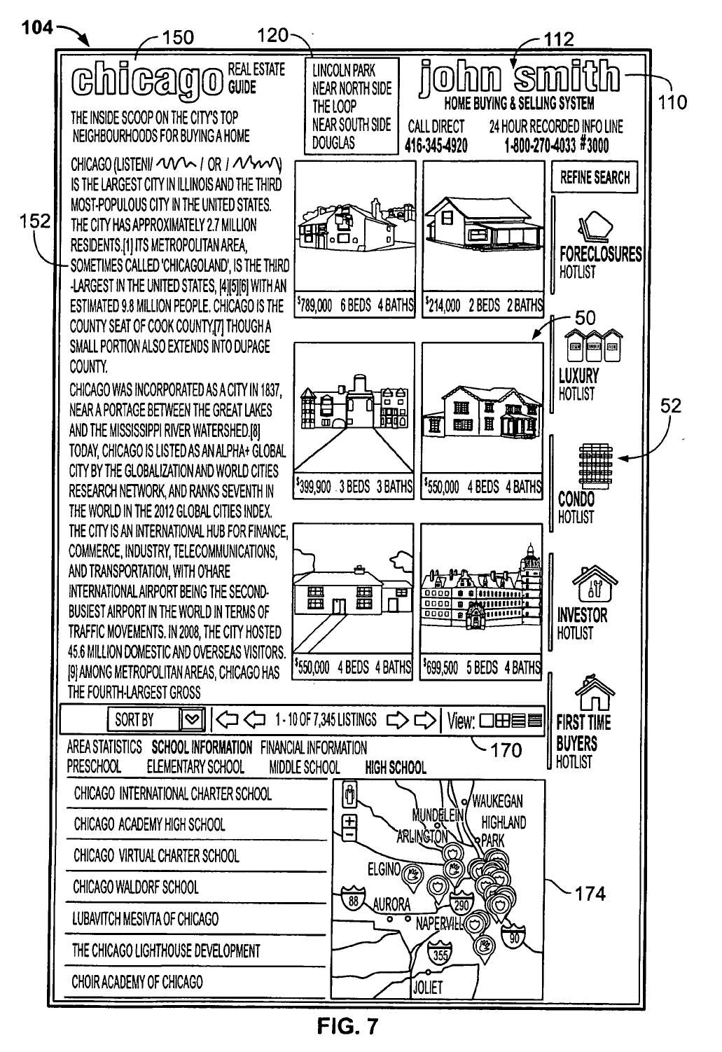

The system 100 according to the present invention may preferably use Internet-sourced location data—e.g., including neighborhood names, zip/postal codes, and/or geo-code boundaries—to select and/or localize properties. This feature of the present invention may be an improved and/or ideal complement to pay-per-click search engine ads, which may have otherwise previously relied on a user to enter a specific area's name to find properties in that area. Preferably, and as shown in FIG. 7, when user input 20 comes from a mobile device, the system 100 according to some preferred embodiments of the present invention may take account of location information 152, preferably implicitly to offer content related to the location 150 where the user is. [According to one aspect of a preferred embodiment of the invention, the user's location 150, or an Internet protocol (“IP”) address that can be used to source their location 150, may be contained within and/or sourced from the referral URL 22 from search engines.]

Example: The system 100 according to the present invention may preferably intelligently generate a list for a community area (e.g., Chicago's Lincoln Park), and/or generate and offer links to sub-divided lists of neighborhoods within that area (e.g., Old Town Triangle, Park West, Lincoln Central). Furthermore, according to the invention, a user who visits an REPCS-generated list from an original Google search for “homes in Lincoln Park” may preferably also be presented with a link to larger community areas, such as “additional homes in the North Side”.

Technical Overview: If a desired result is property data for homes in the same neighborhood or zip code, this may preferably be easily queried according to the invention by looking for matching location information 152 on properties. Additional processing may be required if the desired result is property data 190 for an expanded area. Neighborhoods may have known boundaries defined by geo-codes which may be freely available through queries to map databases 32 such as the Google Maps database. Given location information 152 such as a neighborhood name or zip code, the system 100 according to the present invention may preferably query a map database 32 for geo-code boundaries to determine the area it covers. The system 100 according to the present invention may preferably then expand the geo-code boundaries slightly to locate nearby neighborhoods. Once this is done, the system 100 according to the present invention may preferably calculate the boundaries of the new neighborhood from the map database 32, and include them in the property data query. The system 100 according to the present invention may preferably store limits (in its internal rules system) on how far away to search, e.g., to prevent the property data query from covering too large an area. FIG. 5 provides a high-level diagram of this process.

### (c) Statistical Calculation Selection

The system 100 according to the present invention may preferably perform statistical calculations on property data for selected areas, e.g., to intelligently determine definitions for various property criteria. The system 100 according to the present invention may preferably also use these calculated amounts to sort and/or filter the listings.

Example: The system 100 according to the present invention may preferably calculate a list of inexpensive “first-time buyer homes” in the Chicago area from the list prices of all available homes in Chicago, selecting for example properties below the thirty-third percentile, rather than rely on a fixed range definition such as $200K-$350K. The system 100 according to the present invention may preferably use the former selection method as one which may be more adaptable to market conditions (e.g., such as overall rising or falling price trends, or other relevant factors such as urban vs. suburban homes) without further intervention to “localize” the selection.

The system 100 according to the present invention may preferably perform statistical calculations (e.g., on MLS data) which may include one or more of the following: (a) Distribution analysis to create property data selection ranges (e.g., deviation from a value, and/or percentile curves); (b) Property prices 162 (e.g., median and/or average list price, and/or sale price); (c) Inventory statistics (e.g., total number of houses on market, entering market, and/or leaving market over a certain time period); (d) Market activity (e.g., number of properties sold, and/or median and/or average number of days on market); (e) Most common and/or typical property type in an area; (f) Median and/or average number of bedrooms and bathrooms; and/or (g) Additional calculations defined by the REPCS-provider 110.

Technical Overview: Once the system 100 according to the present invention has selected property data, preferably using a specific set of criteria, the resulting list may preferably be queried (repeatedly if desired) to perform the desired calculation(s). The system 100 according to the present invention may preferably calculate means, averages, sums, and/or counts across the desired database fields of items in the list, as well as more complex distribution analyses such as deviations and percentiles. The system 100 according to the present invention may preferably store, in the internal rules system, the specific calculations to be made for a desired query result. In the “first-time buyer homes” example above, the system 100 according to the present invention may preferably first query property data for all listings in the Chicago area. Preferably, it may then consult the rules system for the current calculation method for “first-time buyer home”, which may according to some preferred embodiments of the invention be, for example, the aforementioned 33rd percentile or lower calculation method. The system 100 according to the present invention may preferably then use that definition to query the list of Chicago listings to calculate the numerical range according to the rules definition. It may preferably then query the list again to filter out listings that don't have a price within that numerical range. Preferably, according to the invention, the result may be a desired list of “first-time buyer homes” for presentation to the user. FIG. 6 provides a high-level overview of the statistical calculation process.

### (d) Ability to Tune REPCS Selection Logic

REPCS-providers 110 may preferably have the flexibility to allow the system 100 according to the present invention to create definitions based on calculated data, and/or fine-tune the definitions by adding more specific details. This may preferably allow the REPCS-provider 110 to customize a knowledge interpreter (of the system 100 according to the present invention) for conditions in their market. Preferably, according to the present invention, the REPCS-provider 110 may also be able to identify “featured properties” that will be preferentially-displayed in the hot list.

Example: Using the same “first-time buyer homes” example as above, the REPCS-provider 110 may choose to tune the system 100 according to the present invention so that the above-referenced “low thirty third percentile” is instead replaced with a “low fiftieth percentile” criteria, or force it to use a $200K-$350K range instead. According to some preferred embodiments of the invention, properties marked as “featured” may appear first on the resulting list and/or in a conspicuous location on the web page.

Technical Overview: The system 100 according to the present invention may preferably rely on its internal rules system for definitions of selection criteria and/or for how to calculate statistical data. According to the invention, the system's default and/or pre-set rules may be determined according to standard real estate practice and/or in keeping with generally agreed-upon conditions. It is important to note that, according to the invention, any of these rules can be fine-tuned and/or resolved by supplying alternative rules and/or further information, such as may be pre-determined and/or later determined by the REPCS-provider 110 or otherwise. In the case of location data, for example, the REPCS-provider 110 may according to the invention specify the boundaries of the neighborhoods they service, which may preferably tune the calculations of selection boundaries from a maps database for the system 100. REPCS-providers 110 wishing to designate “featured properties” may preferably, according to the invention, add an ID code (e.g., an MLS ID number) for that property to a table in an internal database of the system 100, which preferably then may be read during the process of displaying property data to prioritize those items. The process of editing the various rules definitions, according to the invention, may be readily performed by REPCS-providers 110 using custom software and/or interfaces which may be additionally provided.

### Market Currents Reports

The system 100 according to the present invention may preferably perform calculations across available (e.g., MLS) data, and/or incorporate statistics and/or information into market currents reports. According to the invention, the market current reports may preferably describe trends in the market and/or provide homebuyer tips. According to the invention, a short summary of this information may preferably be displayed in parallel with the lists of properties, preferably with a link to an expanded version on a separate page.

The statistical reports according to the present invention may preferably be generated substantially on-demand, preferably based on an intelligently created property list selected by the knowledge interpretation of the system 100, and preferably with little extra input required by the user. According to the present invention, the calculations may preferably also be made on lists of properties selected under atypical conditions. According to the present invention, the use of location data may preferably also allow reports to be created for expanded and/or neighboring areas, preferably for example to allow users to compare market conditions. The system 100 according to the present invention may preferably offer benefits which include increased speed, efficiency and/or flexibility in providing information to individual users.

Example Market Currents Update: “For the Chicago area, the median listing price for single family homes in September is $199,000.00, or $173.95 per square foot. The current number of active listings in the area is 12,852. Listings are active on the market for a median 111 days. 334 properties have been sold. The typical property type in the Chicago area is Condo/Townhouse. Other major property types include Single Family. Properties average 2.79 bedrooms and 1.84 baths. Median home size is 1,144.00 square feet. Median lot size is 0.00. The average list price is $348,289.58, or $1,680.26 per square foot. Home inventory has increased by 6% over the last month—with increased competition, you may be able to negotiate a lower purchase price.”

By way of a further example, the above example could also be generated for properties in the Lincoln Park area, with reports offered for both smaller (Park West) or larger (North Side) areas.

The statistical calculations which may preferably be performed on (e.g., MLS) data by the system 100 according to the present invention include one or more of the following: (a) Property prices 162 (median and/or average list price, and/or sale price); (b) Inventory statistics (total number of houses on market, entering market, and/or leaving market over a certain time period); (c) Market activity (number of properties sold, and/or median and/or average number of days on market); (d) Most common and/or typical property type in an area; and/or (e) Median and/or average number of bedrooms and/or bathrooms.

Technical Overview: [See also the Technical Overview section under point (3)(c) “Statistical Calculation Selection” above.] The calculations to be performed on a set of queried property data may preferably be contained in an internal rules database of the system 100 according to the present invention. Preferably, the calculated data then may be used to fill in fields of a pre-defined report layout, for presentation to a user. In the “Example Market Currents Update” section above, the non-underlined text may preferably (according to the invention) be pre-defined in a database of the system 100, preferably with field codes for the calculated numbers marked hereinabove with underlining. Using the internal rules system, the calculations on the data may preferably be performed and/or substituted in for the various field codes. Conditional commentary 168, such as that which is marked hereinabove with underlining in the last sentence of that section, could be pre-defined in the REPCS-database and/or placed in the report based on the values of calculated data. Where location data is detected in the input, it may preferably be used to calculate and/or offer statistics for the current area, adjoining areas, and/or smaller or expanded areas. FIG. 6 provides a high-level overview of the statistical calculation process.

### Adaptive Web Page Headers and Navigation Links

With the system 100 according to the present invention, header information 58 and/or navigation links on the output list also may preferably be adaptively displayed based on any of the information detailed above, and more. In the case of displaying a hot list on a web page, for example, new navigation links and/or header information 58 may preferably be presented (according to the invention) along with the property information in the hot list.

The system 100 according to the present invention may preferably also dynamically generate a URL for the hot list output 50, preferably one which may allow a user to revisit the list at a future time.

The system 100 according to the present invention may preferably offer one or more of the following innovative benefits: (1) increased speed and/or efficiency in allowing a user to find and/or navigate to additional information; and/or (2) increased search engine optimization, and/or the adaptive header information 58 may preferably contain relevant keywords and/or terms which may be indexed by search engines, preferably allowing the REPCS-provider's website 102,104,106,108 to be more easily located in future searches.

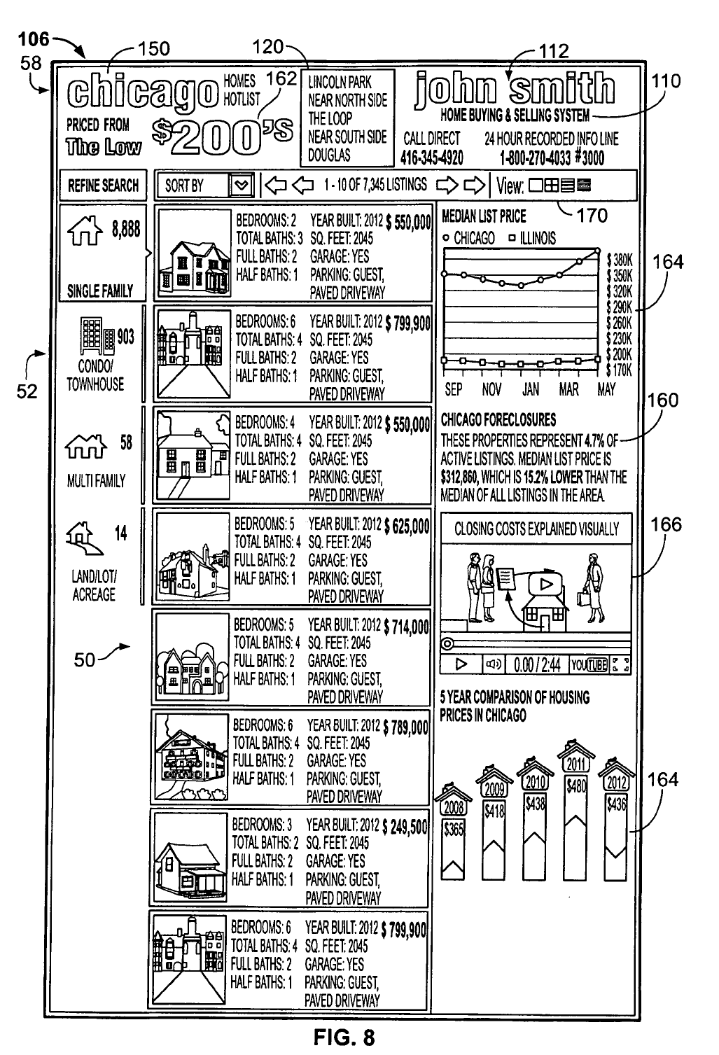

Example: FIG. 8 depicts one web page layout which may be provided according to the present invention (though other layouts with a differing look-and-feel are also within the scope of the present invention). FIG. 8 depicts areas which may preferably, according to the present invention, be intelligently generated along with the list of properties and its accompanying criteria selectors, and can change along with the selection of homes. According to the present invention, each of these areas may preferably also be live, preferably allowing the user to quickly navigate to any of the displayed information. The system 100 according to the present invention may preferably update the whole web page 106 to dynamically generate new navigation links, preferably when the content of the list and/or its selection criteria changes.

The additional information presented beside the property data may preferably, according to the invention, include one or more of the following: calculated statistics and market currents; informative reports; video/multimedia items; additional search keywords; knowledge-based tags (e.g., “First Time Buyer Homes”); and/or links to additional information, preferably including landing pages on the REPCS-provider's website 102,104,106,108.

Technical Overview: Preferably, the information displayed on the web page may be determined by layout rules in an internal system of the system 100 according to the present invention. According to the invention, additional rules may preferably be set to override the defaults, if desired. Neighborhood areas, hot list names, promotional information, and/or the layout of additional information items may preferably, according to the invention, all be specified by the REPCS-provider 110 to create the output they desire.

The present invention encompasses the layouts and looks of the system as presented here, but also extends to encompass other layouts and looks, such as may yet be further developed.

An object of one preferred embodiment of the REPCS is to improve the speed and/or efficiency for users in finding refined “Hot Lists” of properties they might be interested in, with as little interaction as possible. As shown in FIG. 6, users may find hot lists 50 useful, e.g., as a supplement to their own property research. And, the knowledge interpretation provided by system 100 may preferably provide for fast and/or easy access to specific lists.

This philosophy may be reflected in the REPCS Home Page 102, where numerous links to featured hot lists 52 may preferably be presented in anticipation of some of the most popular information users may be looking for. These links may preferably provide for quick selection and/or filtering of property data, and may preferably include one or more of the following: Neighborhood Guides 120; Featured Hot Lists 52; and/or Quick Links 130. Quick Links 130 may provide for various searches, including by: city 131, neighborhood 132, zip code 133, and/or school district 134. Users with more specific needs, desires and/or preferences may be able to directly input and/or select what they want using one or more of the Property Categories buttons 140 and/or the Search Form (alternately “users' search criteria”) 24.

According to the invention, the web page may preferably also provide space for a Custom Banner (alternately a “custom message”) 112 and for the REPCS-provider's Featured Properties 54, preferably allowing the REPCS-provider (alternately “real estate professional”) 110 to promote themselves and/or their services.

Web pages 102,104 generated by the REPCS 100 may preferably be search engine optimization ready (“SEO Ready”), and/or anchor text of the numerous links 52,120,130 generated by the system may preferably contain relevant keywords for indexing by search engines.

As depicted in FIG. 7, Guide Pages 104 may preferably provide Local Area Information (alternately “location information”) 152, along with an overview of properties listed in the area 150, and may preferably also be SEO Ready and/or have relevant keywords present in the links and/or text. Quick access links to featured hot lists 52 (which may include popular hot lists) defined by the REPCS-provider 110 may preferably also be provided—these may preferably link to hot lists filtered by the neighborhood currently being viewed by the user. The REPCS-provider 110 may preferably define static lists using saved search criteria and/or, according to the invention, allow the REPCS to use knowledge interpretation to intelligently create lists based on user input 20.

Note that the REPCS-provider 110 may preferably determine which hot lists and/or neighborhood areas they want to feature on the REPCS-provider's website 102,104,106,108 when it is first setup. According to the invention, the REPCS-provider 110 preferably doesn't have to pre-generate sets of saved search criteria to select lists of properties (although they can certainly do this if they want). REPCS may preferably interpret information from the current page and/or use it to dynamically select and/or filter the Property Data to create lists on demand.

As depicted in FIG. 8, the system 100 may preferably present REPCS-provider-defined Static Lists and/or dynamically-generated ones 106. Preferably, while the methods of property selection and/or list generation may be different, the actual list output may be similar.

With REPCS 100, the entire web page 106 may preferably change as users navigate the site. The header information 58 (i.e., “Chicago Homes Hotlist, Priced From The Low $200's”) may preferably change to provide a visual reminder of what type of list the user is viewing. Preferably, it may also be an easily readable title on hard copy printouts. The system 100 may preferably continue to provide SEO Ready quick links (e.g., such as the provider's Pre-Defined Areas) to allow for quick filtering of lists.

Additional information (alternately “market information”) 160 may preferably be presented on the REPCS web page 106 beside the hot list 50, preferably allowing the REPCS-provider 110 to provide helpful advice and/or demonstrate expertise. The information may preferably include one or more of the following: Summary Property Data 164; Video/Multimedia items 166; and/or additional search keywords, tags, links to the REPCS-provider's website 102,104,106,108, and more.

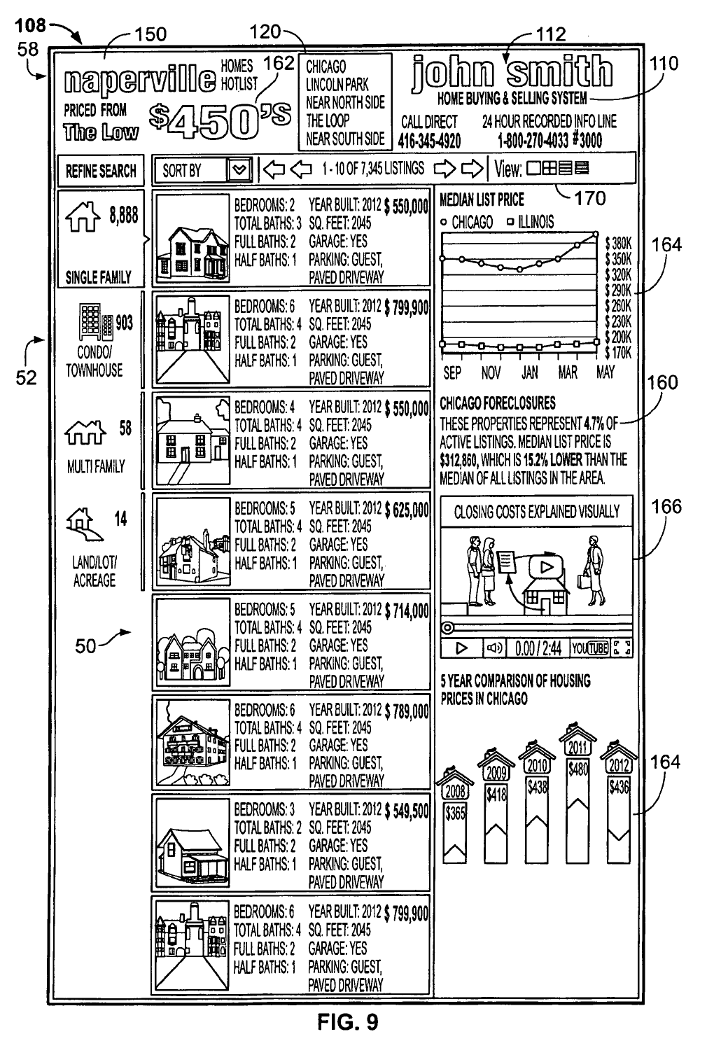

As depicted in FIG. 9, Hot Lists 50 may preferably also be Intelligently-Generated 108 on-demand by the system 100 by applying the knowledge interpretation system 40 to the user input 20. This is possible for any criteria, including among other things: (i) locations 150, neighborhoods, and/or areas; (ii) property types and/or details; and even (iii) statistically-calculated ranges, e.g., such as price percentiles and/or deviations.

This may preferably provide a substantial speed and/or efficiency benefit to REPCS-providers 110, who may preferably be able to provide quick access to lists of specific content without having to pre-define groups of saved search criteria in advance.

As may be appreciated from FIG. 9, the REPCS user may preferably (according to the invention) be able to quickly get to a list of homes in the Chicago neighborhood of Naperville 150, for example, without any prediction and/or pre-generation required by the REPCS-provider 110. They may preferably then be able to quickly filter the list by property type using the buttons 140 provided.

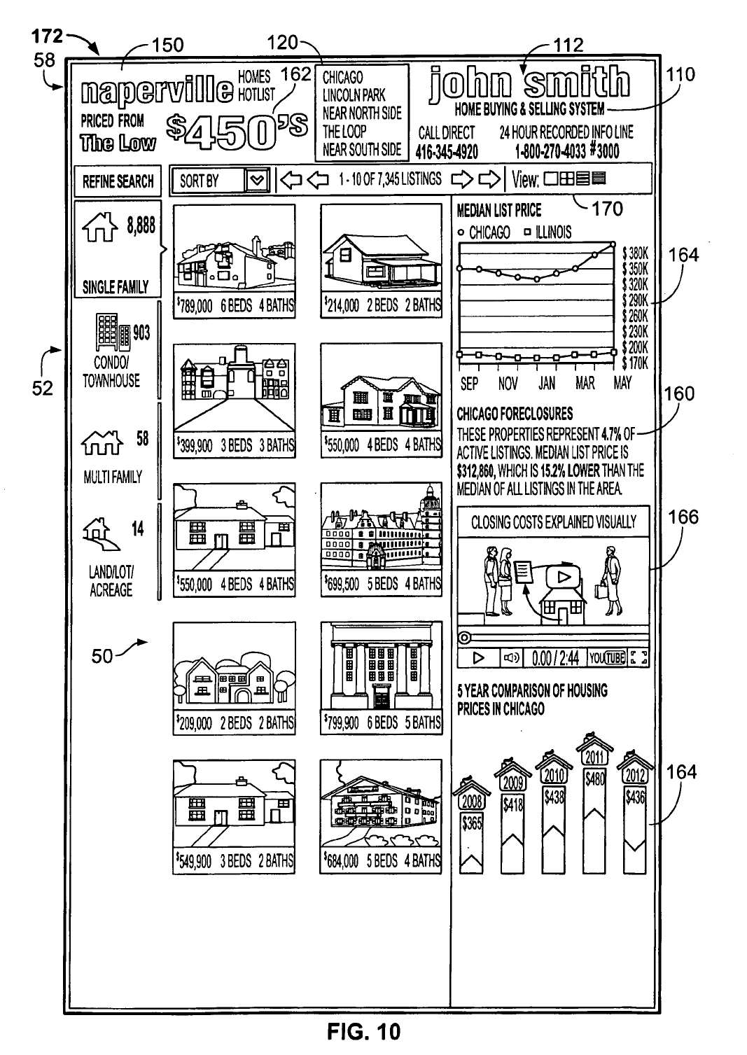

As shown in FIG. 10, alternate layouts of the hot list page may preferably, according to the invention, be easily selected by the REPCS-user using View Controls 170 at the top of the list. FIG. 10 provides an example of a grid view 172—i.e., in the embodiment shown, a grid view 172 provides photos of properties, which users may preferably be able to click for more information. Note the additional information 160 in a different layout. For example, layouts and the info to be presented may be specified by the REPCS-provider 110 at setup, and/or selected by REPCS 100 based on contextual aspects of the current list.

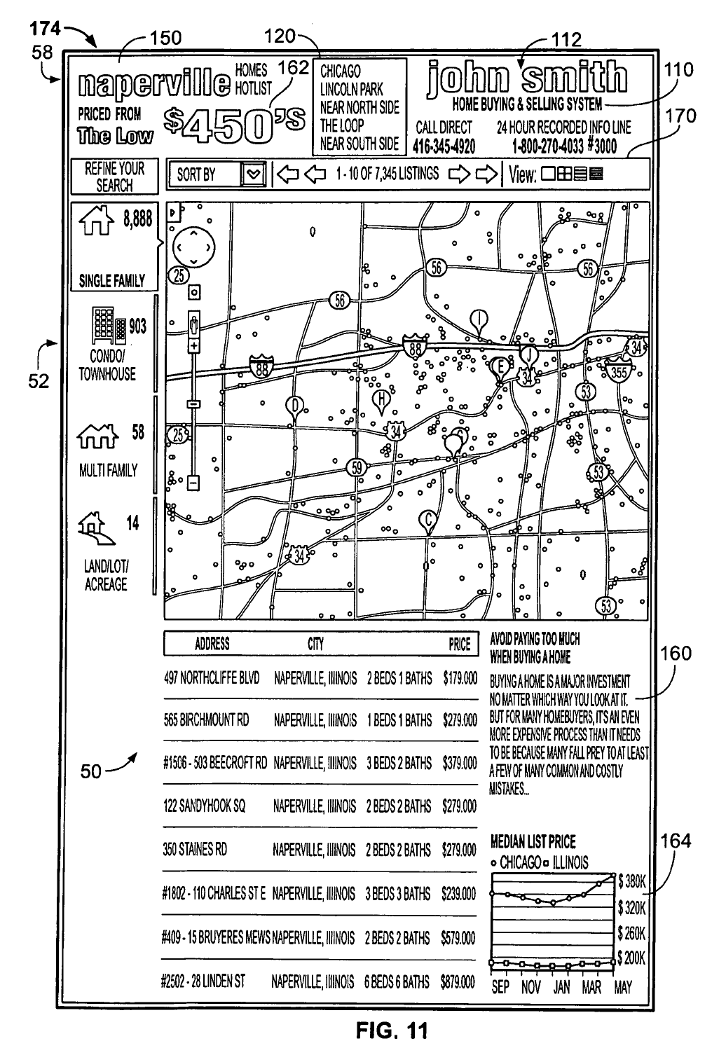

FIG. 11 shows, preferably according to the invention, an additional layout may be the Map View 174, which may preferably plot the location 150 of listed properties on a map of the area.

Additional information 160 may preferably also be presented in the layout depicted in FIG. 11. This figure provides an example of another type of market information 160—Embedded Report & Unique Selling Proposition (“USP”) Links—which may preferably redirect a user to a landing page on the REPCS-provider's website 102,104,106,108.

The system 100 may preferably also provide Mobile Friendly Views (not shown) allowing users of mobile browsers on smartphones and/or tablets the ability to view information in a convenient layout.

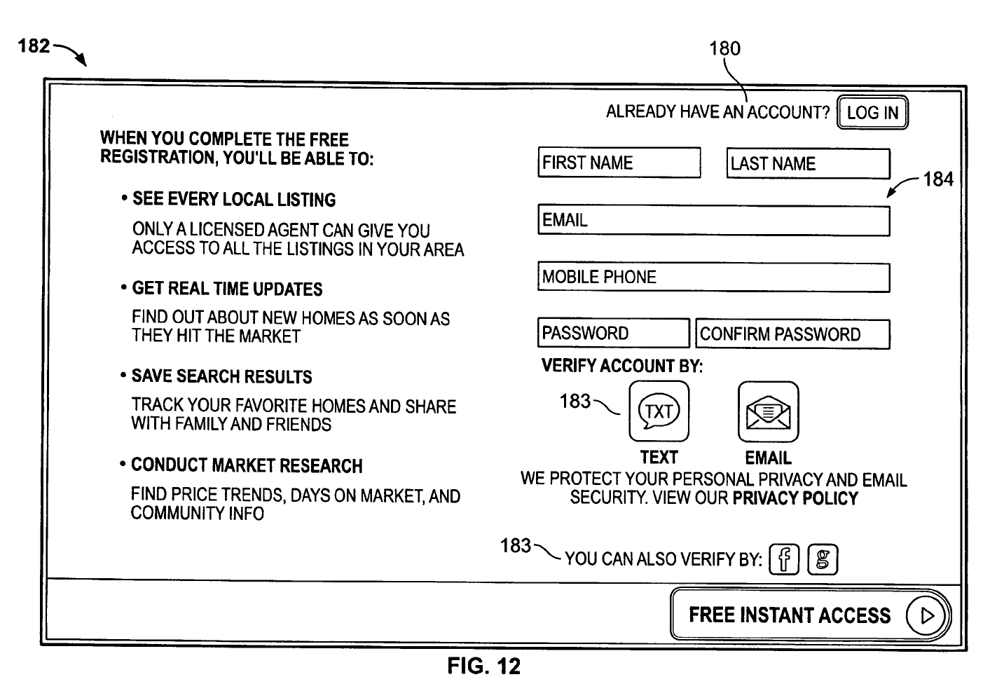

As depicted in FIG. 12, an object of an REPCS-provider 110 in providing Property Data 190 and/or content on their website 102,104,106,108, according to one aspect of a preferred embodiment of the present invention, is to attract and/or capture leads 182 to promote the REPCS-provider's services to clients and/or potential clients, and/or to work towards converting those leads 182 into clients. Without some way of capturing a user's contact information, it may be difficult to accomplish this objective. The system 100 may preferably allow a certain number of Initial “SAMPLE” views before presenting a registration form 184 to a user, which the user may preferably then be required to complete in order to continue viewing property information. This method may preferably allow the system to act as a teaser to encourage the user to register. The registration form 184 may, for example, appear over a home details layout (not shown) presenting information for a specific property including an additional information layout at the bottom thereof, preferably continuing to provide examples of the REPCS-provider's services and/or expertise.

Lead Verification 183 by SMS text message, email, and/or social media sites like Facebook and/or Google may preferably help the REPCS-provider 110 to receive valid contact information for their leads. On signing up, a lead 182 may preferably be required to respond to a message generated by the system 100 using their chosen verification format in order to complete registration and begin using the system 100. Returning users 180 who have already registered may preferably be afforded an option to log-in if REPCS 100 cannot find a registration cookie on the user's computer.

Verifying by social media may preferably, according to the invention, allow for Social Sharing of Homes, Hot Lists, and/or Favorites, preferably by establishing a connection between a user's REPCS account and their social media profile.

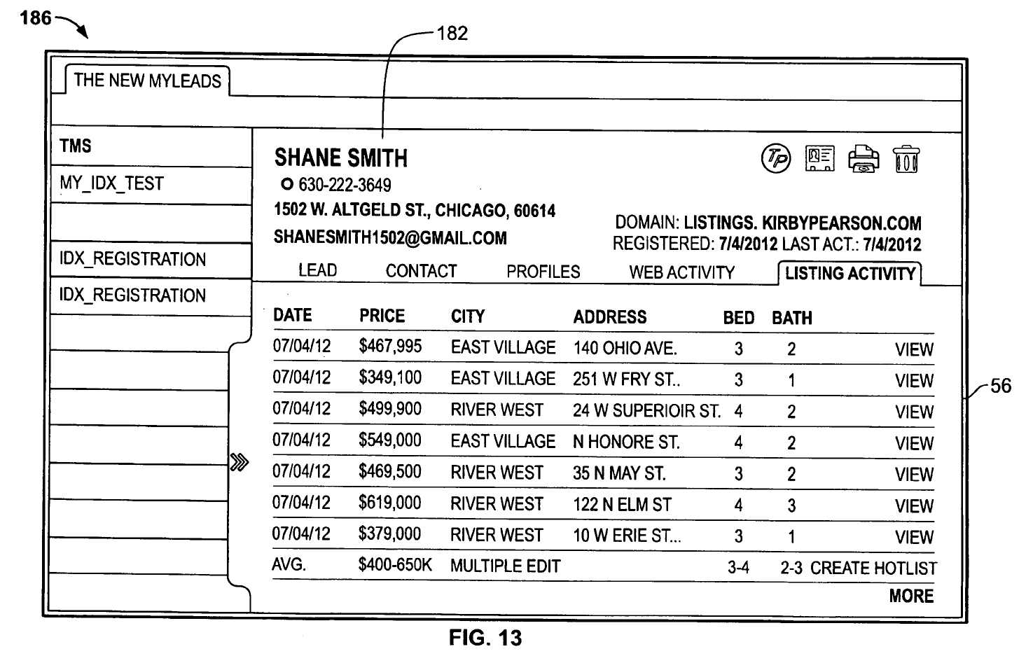

The MyLeads Integration 186 feature according to the invention, as shown in FIG. 13, may preferably integrate with the SuccessWebsite® Solution's MyLeads system (offered by ConsulNet Computing, Inc. of Toronto, Ontario) to record a user's activity once they have registered as a lead 182. The REPCS-provider 110 may preferably, according to the invention, use this information to see what leads 182 may be interested in, preferably before making a follow-up call.

Leads 182 may preferably be profiled with records showing which properties they have marked as Favorites 56, the types of properties viewed, and/or the searches performed. The information may preferably allow the REPCS-provider 110 to “cherry-pick” their best leads 182 and/or to follow-up with them first (if they wish). Through the SuccessWebsite® Solution, the REPCS-provider 110 may preferably also engage in Live Chat with Returning Users 180.

The REPCS-provider 110 may preferably also retain full control of each user's access level to REPCS, e.g., including Basic, Time-Limited, Premium, and No Access levels.

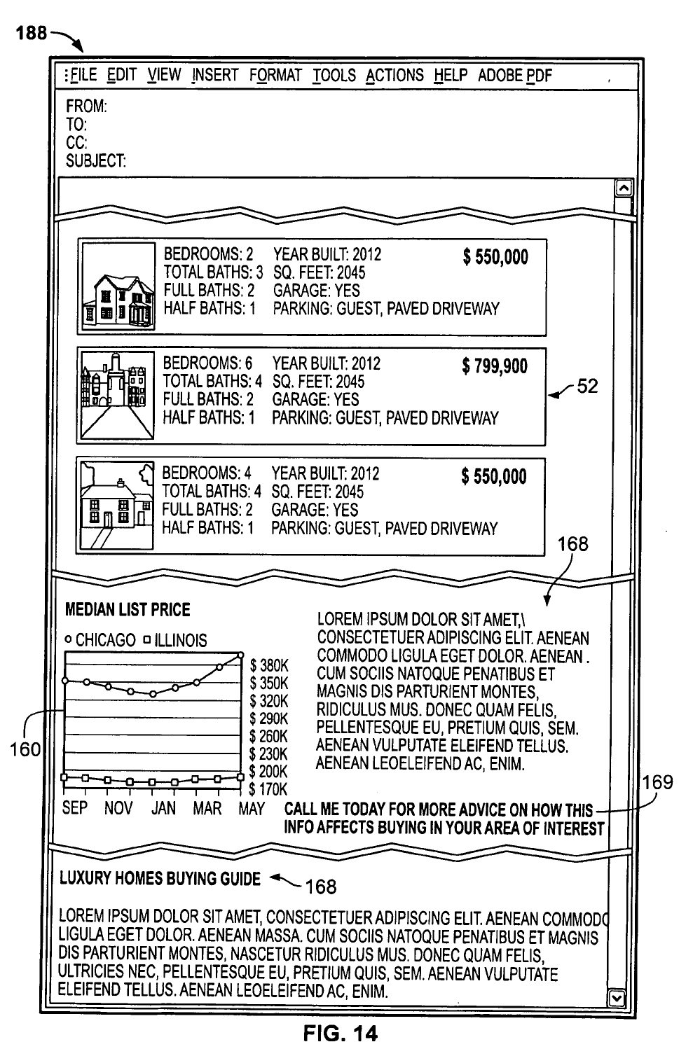

As shown in FIG. 14, REPCS may preferably also integrate with the SuccessWebsite® Solution to follow-up with registered users by email 188, if they have submitted a valid address during registration. Follow-up email messages 188 may preferably contain one or more of the following: (i) New listings matching the lead's search criteria; (ii) Updated Market Currents with REPCS-Provider Commentary 168 and a Call to Action 169 to motivate leads 182 to contact the provider 110; and/or (iii) Additional Info based on the Lead Profile and/or Activity. [In the example shown, the lead 182 has viewed a lot of Luxury Homes, so a “Luxury Homes Buying Guide” has been included in the follow-up message.]

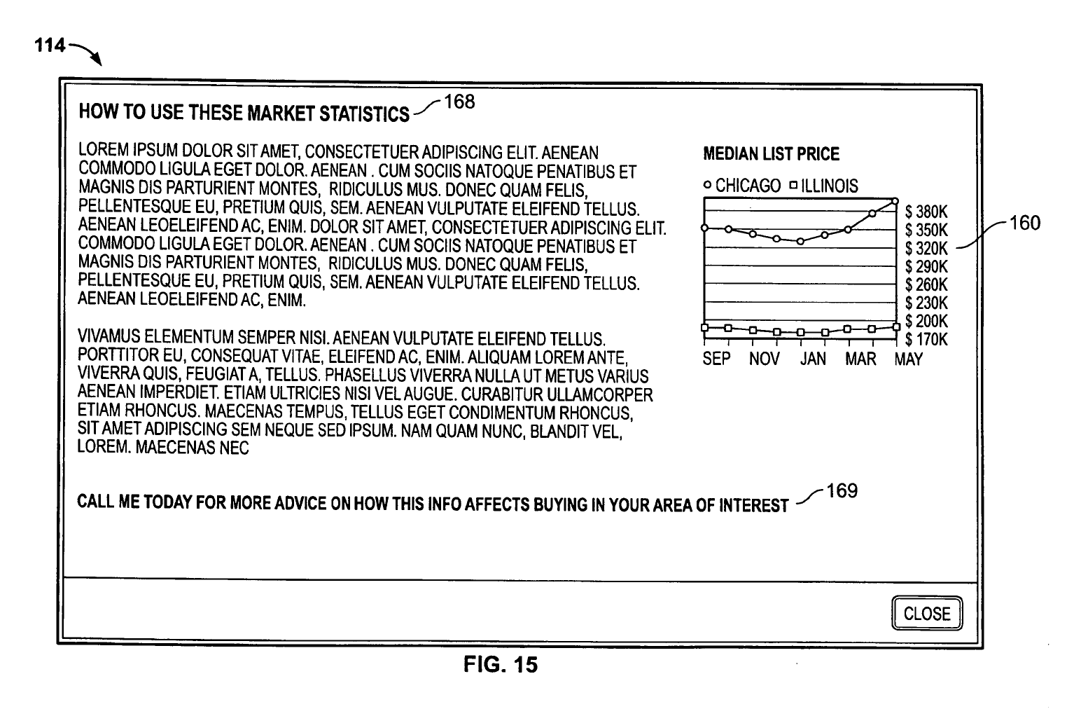

FIG. 15 depicts a Realtor Credibility feature 114. It may be important for any real estate provider promoting their services to establish credibility and/or expertise in real estate transactions. REPCS may preferably provide market information 160, commentary (which may include explanations) 168 of what the trend statistics mean, preferably to support this objective. Included in the explanation text may preferably be a call-to-action 169 to drive the lead 182 to contact the provider, which may preferably help in the process of conversion.

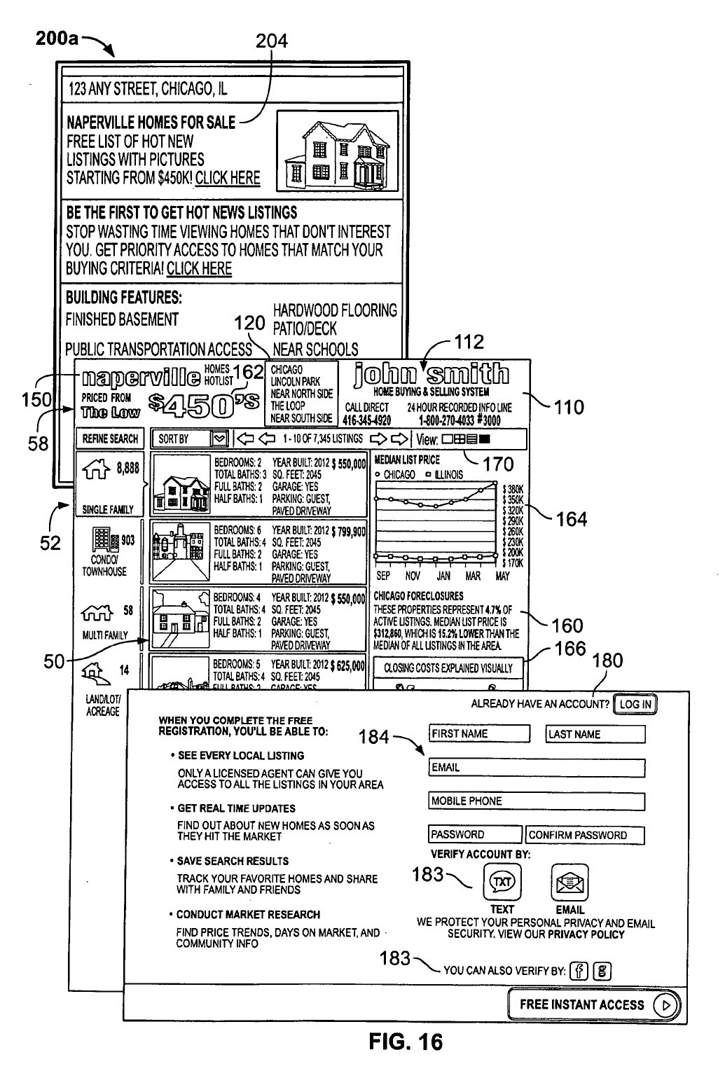

FIG. 16 shows a form of search engine integration (alternately “media integration”) using Craigslist 200a. REPCS 100 may preferably also integrate with online advertisements 204 to Link ads directly to targeted hotlists 50 without the extra user input 20 of selecting properties. Ad types may preferably include online classifieds such as Craigslist and/or offline ads, e.g., such as newspapers and/or postcards.

Ads may preferably link to a Specific Hot List 50 and/or an ad promoting a specific property could link to a Hot List of “Similar Homes”. The system 100 may preferably use special “Referral URLs” 22 which may contain codes allowing the system 100 to intelligently generate the list on-demand, and/or preferably without any pre-generation and/or saved search criteria being created by the REPCS-provider 110.

Preferably through this process, users may be led from the ad to the REPCS website 102,104,106,108, and/or then encouraged to register with the contact form 184. This may preferably accomplish the REPCS-provider's goal of increased lead 182 generation.

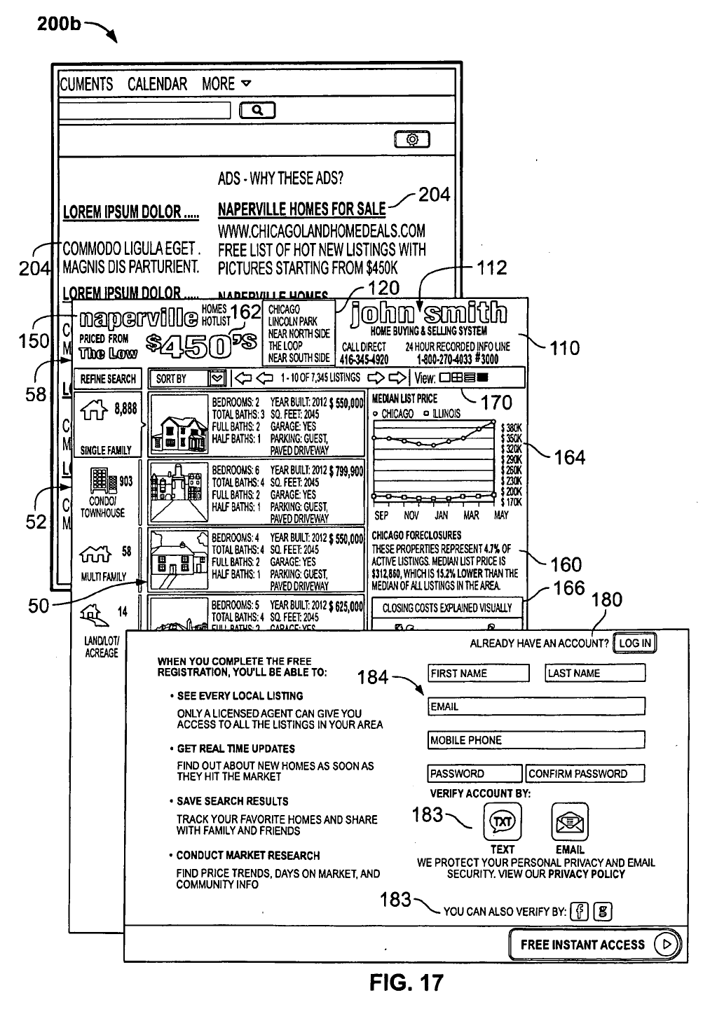

FIG. 17 depicts a form of search engine integration (alternately “media integration”) 200b using AdWords. Preferably, Google Ads may be directly linked to on-the-fly Hot Lists. The Referral URLs 22 may preferably contain pre-defined codes from the ad links or online advertisements 204, and/or include additional data from users, e.g., including the search terms they entered into Google, and/or their IP address and/or mobile location data. REPCS 100 may preferably use this information to intelligently create a customized hot list 50.

The same process of increased lead 182 generation may preferably occur on the REPCS-provider's website 102,104,106,108.

It should be appreciated that, although some of the components, relations, configurations and/or steps of the devices, systems, methods and computer readable media according to the invention are not specifically referenced in association with one another, they may be used, and/or adapted for use, in association therewith.

All of the aforementioned, depicted and various structures, configurations, relationships, utilities and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of any regular patent applications claiming priority herefrom.

This concludes the description of presently preferred embodiments of the invention. The foregoing description has been presented for the purpose of illustration and is not intended to be exhaustive of to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part hereof.

1. A system for use with one or more databases and with a real estate advertisement selected by a consumer end user after presentation by a search engine in response to input from said consumer end user, the system comprising:
(a) a search engine subsystem which receives, from the search engine, real estate pass-through data that comprises said input from said consumer end user;
(b) a database subsystem which sends a real estate hotlist query to said databases and, in response, receives real estate property listing data and market information from said databases; and
(c) a knowledge interpretation subsystem which automatically determines predefined information that corresponds with each said real estate advertisement and which, based on the predefined information and based on the real estate pass-through data, automatically:
(i) determines the real estate hotlist query and thereby determines the real estate property listing data and the market information to be received from said databases for presentation to said consumer end user; and
(ii) processes the real estate property listing data and the market information to determine a real estate hotlist output for presentation to said consumer end user;
whereby the system uses said real estate advertisement and said input from said consumer end user to automatically determine and process the real estate property listing data and the market information for presentation to said consumer end user.

2. The system according to claim 1, wherein the real estate pass-through data further comprises location data associated with said consumer end user, and wherein the knowledge interpretation subsystem automatically processes at least one of (a) the real estate property listing data, and (b) the market information, to determine comparative data which compares the location data and said input for presentation to said consumer end user as part of the real estate hotlist output.

3. The system according to claim 1, wherein the real estate pass-through data further comprises: device data associated with said consumer end user; operating system data associated with said consumer end user;
and/or originating uniform resource locator data associated with said consumer end user.

4. The system according to claim 1, adapted for use with a regional real estate property listing database among said databases.

5. The system according to claim 1, adapted for use with a real estate professional's property listing database among said databases.

6. The system according to claim 1, wherein the knowledge interpretation subsystem automatically, based on the predefined information and based on the real estate pass-through data, processes at least one of (a) the real estate property listing data, and (b) the market information, to determine market statistics for presentation to said consumer end user as part of the real estate hotlist output.

7. The system according to claim 1, wherein the knowledge interpretation subsystem automatically, based on the predefined information and based on the real estate pass-through data, processes at least one of (a) the real estate property listing data, and (b) the market information, to determine one or more market reports for presentation to said consumer end user as part of the real estate hotlist output, wherein the market reports comprise one or more of: property prices, inventory statistics, market activity, one or more most prevalent real estate property types in a selected geographical region; and an enumeration of bedrooms and bathrooms in the most prevalent property types in the selected geographical region.

8. The system according to claim 1, wherein the knowledge interpretation subsystem automatically performs one or more quantitative, semi-quantitative and/or statistical analyses of said input from said consumer end user to, as aforesaid, determine the real estate hotlist query and thereby determine the real estate property listing data and the market information for presentation to said consumer end user.

9. The system according to claim 8, wherein the analyses comprise one or more of: a real estate statistics distribution analysis; a statistical real estate property price analysis; a real estate inventory statistics analysis; a real estate market activity statistics analysis; an assessment of one or more most prevalent real estate property types in a selected geographical region; and an enumeration of bedrooms and bathrooms in the most prevalent property types in the selected geographical region.

10. The system according to claim 1, further comprising a unique uniform resource locator associated with the real estate hotlist output for selective return of said consumer end user to the real estate hotlist output.

11. The system according to claim 1, further comprising at least one system database, and wherein the predefined information comprises metadata, stored in the system database, corresponding to each said real estate advertisement.

12. The system according to claim 1, wherein the knowledge interpretation subsystem automatically, based on a comparison of said input from said consumer end user and said real estate advertisement presented by said search engine in response thereto, determines the real estate hotlist query as aforesaid.

13. The system according to claim 12, wherein the comparison includes an analysis of any partial and exact matches between said input and the predefined information corresponding with said real estate advertisement.

14. The system according to claim 1, wherein the knowledge interpretation subsystem automatically, based on a first one or more of the real estate property listing data selected by said consumer end user, redetermines the real estate hotlist query and thereby redetermines a second one of more of the real estate property listing data to be received from said databases for presentation to said consumer end user.

15. The system according to claim 1, adapted for use with a geographic database among said databases, and wherein the knowledge interpretation subsystem automatically, based on the real estate pass-through data, determines one or more geo-codes and/or boundaries of a first neighborhood associated with the real estate hotlist query of said databases, and redetermines one or more real estate follow-up queries, associated with a second neighborhood surrounding, bounding and/or within the first neighborhood, and thereby redetermines the real estate property listing data and the market information to be received from said databases for presentation to said consumer end user.

16. The system according to claim 1 wherein, in processing the real estate property listing data to determine the real estate hotlist output as aforesaid, the knowledge interpretation subsystem automatically identifies one or more featured ones of the real estate property listing data for presentation to said consumer end user in a conspicuous location on the real estate hotlist output.

17. The system according to claim 1, wherein the knowledge interpretation subsystem automatically determines a user profile, associated with said consumer end user, comprised of one or more of the real estate hotlist output determined for presentation to said consumer end user; the real estate property listing data selected by said consumer end user; the real estate property listing data viewed by said consumer end user; and said input from said consumer end user.

18. The system according to claim 17 wherein, periodically, the knowledge interpretation subsystem automatically, based on the user profile, redetermines the real estate hotlist query and thereby redetermines one or more of (i) the real estate property listing data, and (ii) the market information, for sending to said consumer end user.

19. The system according to claim 1 wherein, after each selection of said real estate advertisement by said consumer end user, the knowledge interpretation subsystem dynamically determines the real estate hotlist output, as aforesaid, based on the pass-through data including said input from said consumer end user.

20. The system according to claim 1, wherein the knowledge interpretation subsystem automatically, based on the predefined information and based on the real estate pass-through data, processes the real estate property listing data and/or the market information to determine the real estate hotlist output at least in part In the form of a visual representation for presentation to said consumer end user.

21. The system according to claim 20, wherein the visual representation comprises one or more of: a graphic representation of the real estate property listing data and/or the market information; an info-graphic representation of the real estate. property listing data and/or the market information; a map representation of the real estate property listing data and/or the market information; a video representation of the real estate property listing data and/or the market Information; and an audiovisual representation of the real estate property listing data and/or the market information.

22. A method for use with one or more databases and with a real estate advertisement selected by a consumer end user after presentation by a search engine in response to input from said consumer end user, the method comprising the steps of:
(a) receiving, from the search engine, real estate pass-through data that comprises said input from said consumer end user;
(b) sending a real estate hotlist query to said databases and, in response, receiving real estate property listing data and market information from said databases; and
(c) automatically determining predefined information that corresponds with each said real estate advertisement and, based on the predefined information and based on the real estate pass-through data, automatically;
(i) determining the real estate hotlist query and thereby determining the real estate property listing data and the market information to be received from said databases for presentation to said consumer end user; and
(ii) processing the real estate property listing data and the market information to determine a real estate hotlist output for presentation to said consumer end user;
whereby the method uses said real estate advertisement and said input from said consumer end user to automatically determine and process the real estate property listing data and the market information for presentation to said consumer end user.

23. The method according to claim 22 wherein, in step (a), the real estate pass-through data further comprises location data associated with said consumer end user, and further comprising in step (c), automatically processing at least one of the real estate property listing data, and the market information, to determine comparative data which compares the location data and said input for presentation to said consumer end user as part of the real estate hotlist output.

24. The method according to claim 22 wherein, in step (a), the real estate pass-through data further comprises: device data associated with said consumer end user; operating system data associated with said consumer end user, and/or originating uniform resource locator data associated with said consumer end user.

25. The method according to claim 22 adapted for use, in step (b), with a regional real estate properly listing database among said databases.

26. The method according to claim 22 adapted for use, in step (b), with a real estate professional's property listing database among said databases.

27. The method according to claim 22, further comprising in step (c), based on the predefined information and based on the real estate pass-through data, automatically processing at least one of the real estate property listing data, and the market information, to determine market statistics for presentation to said consumer end user as part of the real estate hotlist output.

28. The method according to claim 22, further comprising in step (c), based on the predefined information and based on the real estate pass-through data, automatically processing at least one of the real estate property listing data, and the market information, to determine one or more market reports for presentation to said consumer end user as part of the real estate hotlist output, wherein the market reports comprise one or more of property prices, inventory statistics, market activity, one or more most prevalent real estate property types in a selected geographical region; and an enumeration of bedrooms and bathrooms in the most prevalent property types in the selected geographical region.

29. The method according to claim 22 wherein, in step (c), one or more quantitative, semi-quantitative and/or statistical analyses of said input from said consumer end user are automatically performed to, as aforesaid, determine the real estate hotlist query and thereby determine the real estate property listing data and the market information for presentation to said consumer end user.

30. The method according to claim 29, wherein the analyses comprise one or more of a real estate statistics distribution analysis; a statistical real estate property price analysis; a real estate inventory statistics analysis; a real estate market activity statistics analysis; an assessment of one or more most prevalent real estate property types in a selected geographical region; and an enumeration of bedrooms and bathrooms in the most prevalent property types in the selected geographical region.

31. The method according to claim 22, further comprising generating a unique uniform resource locator in association with the real estate hotlist output for selective return of said consumer end user to the real estate hotlist output.

32. The method according to claim 22, further comprising providing at least one system database; and wherein, in step (c), the predefined information comprises metadata, stored in the system database, corresponding to each said real estate advertisement.

33. The method according to claim 22, wherein in step (c), the real estate hotlist query is automatically determined based on a comparison of said input from said consumer end user and said real estate advertisement presented by said search engine in response thereto.

34. The method according to claim 33, wherein in step (c), the comparison includes an analysis of any partial and exact matches between said input and the predefined information corresponding with said real estate advertisement.

35. The method according to claim 22 further comprising, in step (c), automatically redetermining the real estate hotlist query, based on a first one or more of the real estate property listing data selected by said consumer end user, and thereby redetermining a second one of more of the real estate property listing data to be received from said databases for presentation to said consumer end user.

36. The method according to claim 22 adapted for use, in step (b), with a geographic database among said databases; and further comprising in step (c), automatically: determining one or more geo-codes and/or boundaries of a first neighborhood associated with the real estate hotlist query of said databases based on the real estate pass-through data, redetermining one or more real estate follow-up queries associated with a second neighborhood surrounding, bounding and/or within the first neighborhood, and thereby redetermining the real estate property listing data and the market information to be received from said databases for presentation to said consumer end user.

37. The method according to claim 22, further comprising in step (c)(ii), automatically identifying one or more featured ones of the real estate property listing data for presentation to said consumer end user in a conspicuous location on the real estate hotlist output.

38. The method according to claim 22, further comprising in step (c), automatically determining a user profile, associated with said consumer end user, comprised of one or more of: the real estate hotlist output determined for presentation to said consumer end user; the real estate property listing data selected by said consumer end user; the real estate property listing data viewed by said consumer end user, and said input from said consumer end user.

39. The method according to claim 38, further comprising in step (c), periodically, automatically: redetermining the real estate hotlist query based on the user profile, and thereby redetermining one or more of the real estate property listing data, and the market information, for sending to said consumer end user.

40. The method according to claim 22, further comprising in step (c), after each selection of said real estate advertisement by said consumer end user, dynamically determining the real estate hotlist output, as aforesaid, based on the pass-through data including said input from said consumer end user.

41. The method according to claim 22 wherein, in step (c)(ii), the real estate property listing data and/or the market information are processed to determine the real estate hotlist output at least in part in the form of a visual representation for presentation to said consumer end user.

42. The method according to claim 41 wherein, in step (c)(II), the visual representation comprises one or more of a graphic representation of the real estate property listing data and/or the market information; an info-graphic representation of the real estate property listing data and/or the market information; a map representation of the real estate property listing data and/or the market information; a video representation of the real estate property listing data and/or the market information; and an audiovisual representation of the real estate property listing data and/or the market information.

43. A computer readable medium for use with one or more databases and with a real estate advertisement selected by a consumer end user after presentation by a search engine in response to input from said consumer end user, the computer readable medium encoded with executable instructions to, when executed, encode one or more processors to automatically perform the steps of:
(a) receiving, from the search engine, real estate pass-through data that comprises said input from said consumer end user;
(b) sending a real estate hotlist query to said databases and, in response, receiving real estate property listing data and market information from said databases; and
(c) automatically determining predefined information that corresponds with each said real estate advertisement and, based on the predefined information and based on the real estate pass-through data, automatically:
(i) determining the real estate hotlist query and thereby determining the real estate property listing data and the market information to be received from said databases for presentation to said consumer end user; and
(ii) processing the real estate property listing data and the market information to determine a real estate hotlist output for presentation to said consumer end user;
whereby the computer readable medium and the executable instructions encode the processors to use said real estate advertisement and said input from said consumer end user to automatically determine and process the real estate property listing data and the market information for presentation to said consumer end user.

44. The computer readable medium according to claim 43, wherein the executable instructions, when executed, further encode the processors to: in step (a), receive location data associated with said consumer end user, as part of the real estate pass-through data; and in step (c), automatically process at least one of the real estate property listing data, and the market information, to determine comparative data which compares the location data and said input for presentation to said consumer end user as part of the real estate hotlist output.

45. The computer readable medium according to claim 43, wherein the executable instructions, when executed, further encode the processors to receive, in step (a), as part of the real estate pass-through data device data associated with said consumer end user; operating system data associated with said consumer end user; and/or originating uniform resource locator data associated with said consumer end user.

46. The computer readable medium according to, wherein the executable instructions, when executed, further encode the processors for use, in step (b), with a regional real estate property listing database among said databases.

47. The computer readable medium according to claim 43, wherein the executable instructions, when executed, further encode the processors for use, in step (b), with a real estate professional's property listing database among said databases.

48. The computer readable medium according to claim 43, wherein the executable instructions, when executed. further encode the processors to, in step (c) based on the predefined information and based on the real estate pass-through data, automatically process at least one of the real estate property listing data, and the market information, to determine market statistics for presentation to said consumer end user as part of the real estate hotlist output.

49. The computer readable medium according to claim 43, wherein the executable instructions, when executed, further encode the processors to, in step (c) based on the predefined information and based on the real estate pass-through data, automatically process at least one of the real estate property listing data, and the market information, to determine one or more market reports for presentation to said consumer end user as part of the real estate hotlist output, wherein the market reports comprise one or more of: property prices, inventory statistics, market activity, one or more most prevalent real estate property types in a selected geographical region; and an enumeration of bedrooms and bathrooms in the most prevalent property types in the selected geographical region.

50. The computer readable medium according to claim 43, wherein the executable instructions, when executed, further encode the processors to, in step (c), automatically perform one or more quantitative, semi-quantitative and/or statistical analyses of said input from said consumer end user to, as aforesaid, determine the real estate hotlist query and thereby determine the real estate property listing data and the market information for presentation to said consumer end user.

51. The computer readable medium according to claim 50, wherein the executable instructions, when executed, further encode the processors such that the analyses comprise one or more of; a real estate statistics distribution analysis; a statistical real estate property price analysis; a real estate inventory statistics analysis; a real estate market activity statistics analysis; an assessment of one or more most prevalent real estate property types in a selected geographical region; and an enumeration or bedrooms and bathrooms in the most prevalent property types in the selected geographical region.

52. The computer readable medium according to claim 43, wherein the executable instructions, when executed, further encode the processors to generate a unique uniform resource locator in association with the real estate hotlist output for selective return of said consumer end user to the real estate hotlist output.

53. A computer readable medium according to claim 43, wherein the executable instructions, when executed, further encode the processors to retrieve from at least one system database, in step (c) metadata corresponding to each said real estate advertisement as at least a part of the predefined information.

54. A computer readable medium according to claim 43, wherein the executable instructions, when executed, further encode the processors to in step (c), automatically determine the real estate hotlist query based on a comparison of said input from said consumer end user and said re& estate advertisement presented by said search engine In response thereto.

55. The computer readable medium according to claim 54, wherein the executable instructions, when executed, further encode the processors such that, in step (c), the comparison includes an analysis of any partial and exact matches between said input and the predefined information corresponding with said real estate advertisement.

56. The computer readable medium according to claim 43, wherein the executable instructions, when executed, further encode the processors to, in step (c). automatically: redetermine the real estate hotlist query based on a first one or more of the real estate property listing data selected by said consumer end user, and thereby redetermine a second one of more of the real estate property listing data to be received from said databases for presentation to said consumer end user.

57. The computer readable medium according to claim 43, wherein the executable instructions, when executed, further encode the processors for use, In step (b), with a geographic database among said databases and, in step (c), to automatically: determine one or more geo-codes and/or boundaries of a first neighborhood associated with the real estate hotlist query of said databases based on the real estate pass-through data; redetermine one or more real estate follow-up queries associated with a second neighborhood surrounding, bounding and/or within the first neighborhood; and thereby redetermine the real estate property listing data and the market information to be received from said databases for presentation to said consumer end user.

58. The computer readable medium according to claim 43, wherein the executable instructions, when executed. further encode the processors to, in step (c)(ii), automatically identify one or more featured ones of the real estate property listing data for presentation to said consumer end user in a conspicuous location on the real estate hotlist output.

59. The computer readable medium according to claim 43, wherein the executable instructions, when executed, further encode the processors to, In step (c), automatically determine a user profile, associated with said consumer end user, comprised of one or more of: the real estate hotlist output determined for presentation to said consumer end user; the real estate property listing data selected by said consumer end user, the real estate property listing data viewed by said consumer end user; and said input from said consumer end user.

60. The computer readable medium according to claim 59, wherein the executable instructions, when executed, further encode the processors to, in step (c), periodically and automatically: redetermine the real estate hotlist query based on the user profile, and thereby redetermine one or more of the real estate property listing data, and the market information for sending to said consumer end user.

61. The computer readable medium according to claim 43, wherein the executable instructions, when executed, further encode the processors to, in step (c) after each selection of said real estate advertisement by said consumer end user, dynamically determine the real estate hotlist output, as aforesaid, based on the pass-through data including said input from said consumer end user.

62. The computer readable medium according to claim 43, wherein the executable instructions, when executed, further encode the processors to, in step (c)(ii), process the real estate property listing data and/or the market information to determine the real estate hotlist output at least in part in the form of a visual representation for presentation to said consumer end user.

63. The computer readable medium according to claim 62, wherein the executable instructions, when executed, further encode the processors such that, in step (c)(ii), the visual representation comprises one or more on a graphic representation of the real estate property listing data and/or the market information; an info-graphic representation of the real estate property listing data and/or the market information; a map representation of the real estate property listing data and/or the market information; a video representation of the real estate property listing data and/or the market information; and an audiovisual representation of the real estate property listing data and/or the market information.
